(19) United States
(12) Patent Application Publication
(10) Pub. No.: US 2024/0354694 A1
(43) Pub. Date: Oct. 24, 2024

(54) COMPUTERIZED SYSTEMS AND METHODS FOR PRODUCT SCRAPPING AND PRODUCT PROCESSING

(71) Applicant: Coupang Corp., Seoul (KR)

(72) Inventors: Seokyoung LEEM, Incheon (KR); Inwoo PARK, Gyeonggi-do (KR); Jaeheon JEONG, Gyeonggi-do (KR); Iljin LEE, Incheon (KR); Bo CHEN, Shanghai (CN); Kwan Woo KO, Seoul (KR); Heon Young HA, Guri-si (KR); Su Hyun JEONG, Gyeonggi-do (KR); Hyungjun SHIM, Hwaseong-si (KR); Issac KWON, Goyang-si (KR); Namho KIM, Sejong-si (KR); Seohyun KAHNG, Seoul (KR); Yu ZHOU, Shanghai (CN)

(21) Appl. No.: 18/135,946

(22) Filed: Apr. 18, 2023

(51) Int. Cl. G06Q 10/087; B65G 1/137; G06Q 10/30; G06Q 30/0207

(52) U.S. Cl. CPC G06Q 10/087; B65G 1/1371; B65G 1/1373; G06Q 10/30; G06Q 30/0207

(57) ABSTRACT

Embodiments include systems and methods for product scrapping and processing. Methods may include transmitting a list of stock keeping units (SKUs) to an interface; causing an external system to determine the location identifier associated with each SKU, command at least one automated guided vehicle (AGV) to retrieve each SKU, and transport each SKU to at least one terminal; compare, by a user device associated with the at least one terminal, the registered SKU identifier with a physical SKU identifier; when the registered SKU identifier is consistent with the physical SKU identifier: transport the corresponding SKU to undergo a scrapping process or a conversion process; when the registered SKU identifier is inconsistent with the physical SKU identifier: perform logic steps to assess the corresponding SKU, and modify the registered SKU identifier according to results of the performed logic steps.

### TECHNICAL FIELD

The present disclosure generally relates to computerized systems and methods for product scrapping and product processing. In particular, embodiments of the present disclosure relate to inventive and unconventional systems relate to transmitting a list of stock keeping units (SKUs) to an interface; causing an external system to determine the location identifier associated with each SKU, command at least one automated guided vehicle (AGV) to retrieve each SKU, and transport each SKU to at least one terminal; and transporting the corresponding SKU to undergo a scrapping process or a conversion process.

### BACKGROUND

Fresh food inventory management presents many challenges in almost all e-commerce companies. When placing purchase orders (PO), there is a target demand period starting from the expected delivery day to the demand period end day. After the demand period, when inventory exceeds its sellable life, it must be discarded. The inventory that must be discarded, also known as scrap, presents a key challenge to making fresh food retailing profitable.

This challenge may be further exacerbated by the fact that in many typical e-commerce systems, a warehouse does not have real-time access to the location of each stock keeping unit (SKU) of products in the warehouse. For example, the location of each SKU may be managed by an external system. As another example, the location of each SKU may be constantly and/or automatically changing due to aging/expiration of products. As a result, these systems suffer from the inability to efficiently track of the locations of SKUs to fulfill POs.

Moreover, typical e-commerce systems suffer from low throughput of PO fulfillment due to lack of manpower and time-intensive processing in warehouses. For example, operators may spend excessive time determining the locations of different SKUs in a warehouse since they do not have real-time access to the locations of the SKUs. As a result of the excessive time spent picking or stowing products in warehouses, typical e-commerce systems must limit POs from customers, thereby resulting in low throughput.

This can be further detrimental and result in reduced quality and efficiency with respect to fresh food inventory (e.g., products that can expire). For example, as a result of the inefficiency in tracking locations of products and time-intensive processing in warehouses, products may expire, thereby becoming unsellable. In some instances, products may be inaccurately tagged as expired when they are actually sellable, resulting in unnecessary scrapping of products and additional inefficiencies (e.g., performing unnecessary scrapping processes, unnecessary inventory reduction, profit loss, etc.).

Therefore, there is a need for improved methods and systems for product scrapping and product processing.

### SUMMARY

One aspect of the present disclosure is directed to a computer-implemented system for product scrapping and processing, the system comprising: a memory storing instructions; and at least one processor configured to execute the instructions to: generate a list of stock keeping units (SKUs), wherein each SKU comprises at least one product and a registered SKU identifier; transmit the list of SKUs to an interface, in response to receiving the list of SKUs, the interface: generates a request to determine a location identifier associated with each SKU of the plurality of SKUs, and transmits the request to an external system to cause the external system to: determine the location identifier associated with each SKU, command at least one automated guided vehicle (AGV) to retrieve each SKU, and transport each SKU to at least one terminal; compare, by a user device associated with the at least one terminal, the registered SKU identifier with a physical SKU identifier; when the registered SKU identifier is consistent with the physical SKU identifier: transport the corresponding SKU to undergo a scrapping process or a conversion process; when the registered SKU identifier is inconsistent with the physical SKU identifier: perform logic steps to assess the corresponding SKU, and modify the registered SKU identifier according to results of the performed logic steps.

Another aspect of the present disclosure is directed to a computer-implemented method for product scrapping and processing, the system comprising: generating a list of stock keeping units (SKUs), wherein each SKU comprises at least one product and a registered SKU identifier; transmitting the list of SKUs to an interface, in response to receiving the list of SKUs, the interface: generating a request to determine a location identifier associated with each SKU of the plurality of SKUs, and transmitting the request to an external system to cause the external system to: determine the location identifier associated with each SKU, command at least one automated guided vehicle (AGV) to retrieve each SKU, and transport each SKU to at least one terminal; comparing, by a user device associated with the at least one terminal, the registered SKU identifier with a physical SKU identifier; when the registered SKU identifier is consistent with the physical SKU identifier: transporting, by one of a mobile receptacle or the AGV, the corresponding SKU to undergo a scrapping process or a conversion process; when the registered SKU identifier is inconsistent with the physical SKU identifier: performing logic steps to assess the corresponding SKU, and modifying the registered SKU identifier according to results of the performed logic steps.

Yet another aspect of the present disclosure is directed to a computer-implemented system for product scrapping and processing, the system comprising: a memory storing instructions; and at least one processor configured to execute the instructions to: generate a list of stock keeping units (SKUs), wherein each SKU comprises at least one product and a registered SKU identifier; transmit the list of SKUs to an interface, in response to receiving the list of SKUs, the interface: generates a request to determine a location identifier associated with each SKU of the plurality of SKUs, and transmits the request to an external system to cause the external system to: determine the location identifier associated with each SKU, command at least one automated guided vehicle (AGV) to retrieve each SKU, and transports each SKU to at least one terminal; compare, by a user device associated with the at least one terminal, the registered SKU identifier with a physical SKU identifier; when the registered SKU identifier is consistent with the physical SKU identifier: transport, by one of a mobile receptacle or the AGV, the corresponding SKU to undergo a scrapping process or a conversion process; when the registered SKU identifier is inconsistent with the physical SKU identifier: perform logic steps to assess the corresponding SKU, and modify the registered SKU identifier according to results of the performed logic steps; modify a data structure of the computer-implemented system and cause a data structure of the external system to be modified according to any one of the scrapping process, the conversion process, or the results of the performed logic steps of the corresponding SKU; and modify the registered SKU identifier of the corresponding SKU to indicate whether it is sellable.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a schematic block diagram illustrating an exemplary embodiment of a network comprising computerized systems for product scrapping and product processing, consistent with the disclosed embodiments.

FIG. 4 is a diagram of a process for product scrapping based on expiration dates, consistent with the disclosed embodiments.

FIG. 5A is a diagram of a process for product conversion based on expiration dates, consistent with the disclosed embodiments.

FIG. 5B is a diagram of a continuation from FIG. 5A of a process for product conversion based on expiration dates, consistent with the disclosed embodiments.

FIG. 6A is a diagram of a process for product scrapping or product conversion based on manufacturing dates, consistent with the disclosed embodiments.

FIG. 6B is a diagram of a continuation from FIG. 6A of a process for product scrapping or product conversion based on manufacturing dates, consistent with the disclosed embodiments.

FIG. 7 is a schematic diagram illustrating AGVs, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for product scrapping and processing. For example, the system may include: a memory storing instructions; and at least one processor configured to execute the instructions to: generate a list of stock keeping units (SKUs), wherein each SKU comprises at least one product and a registered SKU identifier; transmit the list of SKUs to an interface, in response to receiving the list of SKUs, the interface: generates a request to determine a location identifier associated with each SKU of the plurality of SKUs, and transmits the request to an external system; in response to receiving the request, the external system determines the location identifier associated with each SKU, commands at least one automated guided vehicle (AGV) to retrieve each SKU, and transports, by the AGV, each SKU to at least one terminal; compare, by a user device associated with the at least one terminal, the registered SKU identifier with a physical SKU identifier; when the registered SKU identifier is consistent with the physical SKU identifier: transport, by one of a mobile receptacle or the AGV, the corresponding SKU to undergo a scrapping process or a conversion process; when the registered SKU identifier is inconsistent with the physical SKU identifier: perform logic steps to assess the corresponding SKU, and modify the registered SKU identifier according to results of the performed logic steps; modify a data structure of the computer-implemented system and a data structure of the external system according to any one of the scrapping process, the conversion process, or the results of the performed logic steps of the corresponding SKU; and modify the registered SKU identifier of the corresponding SKU to indicate whether it is sellable.

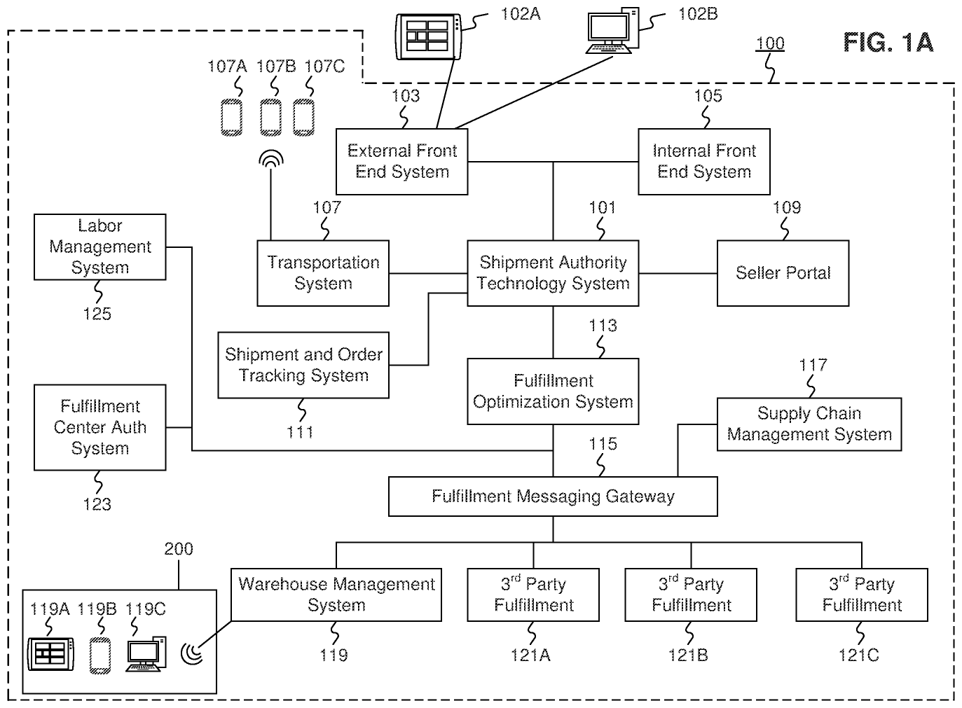

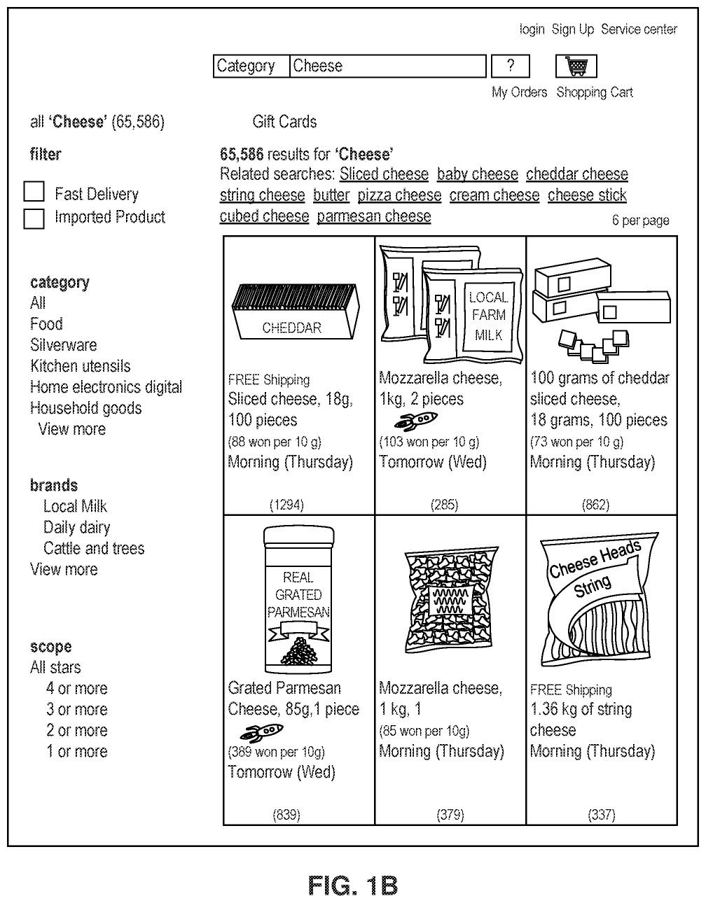

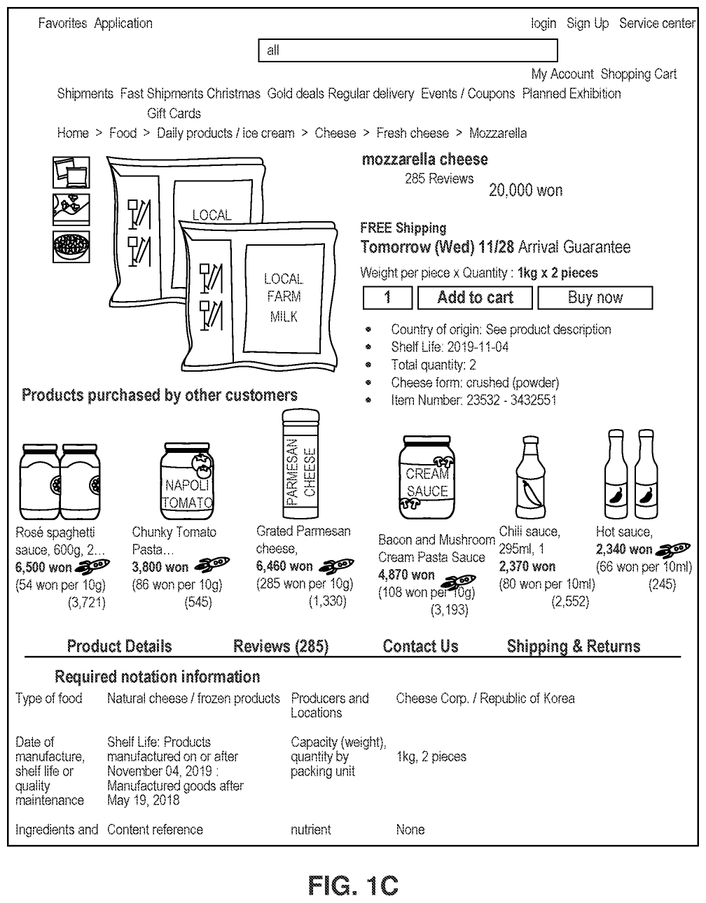

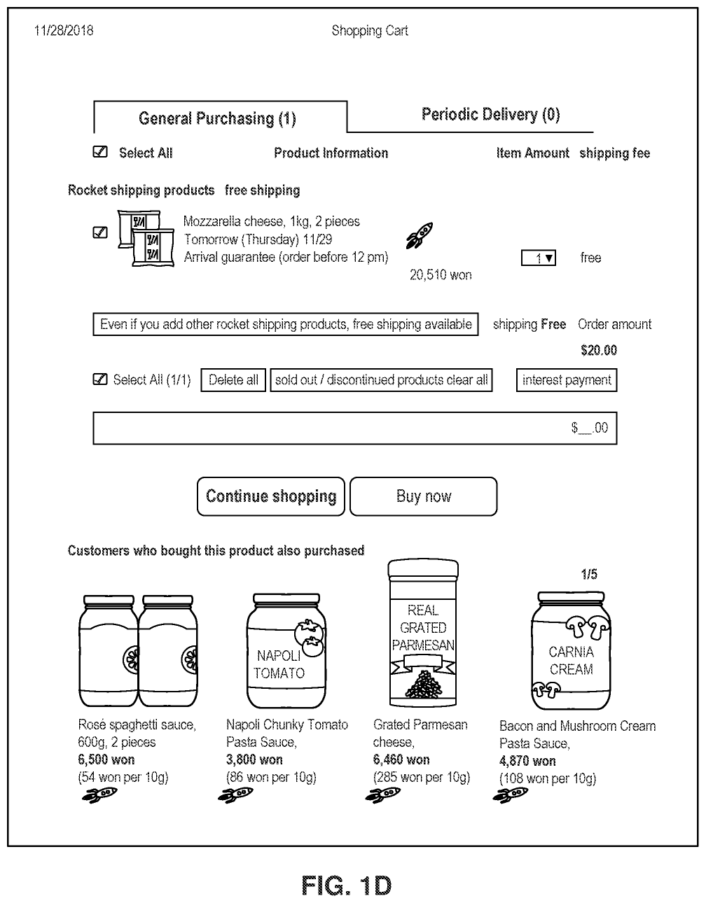

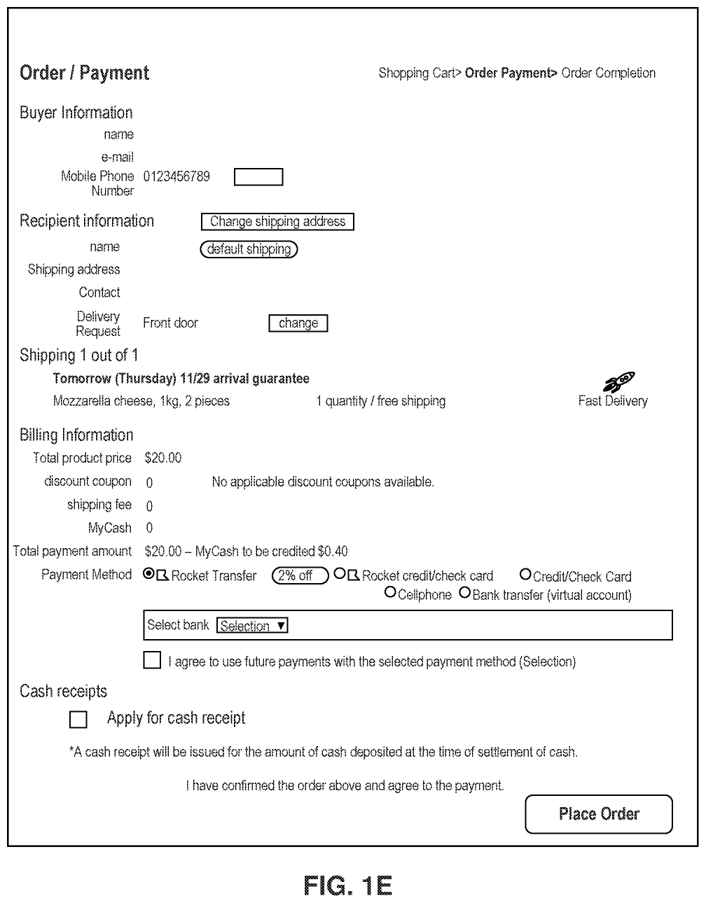

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

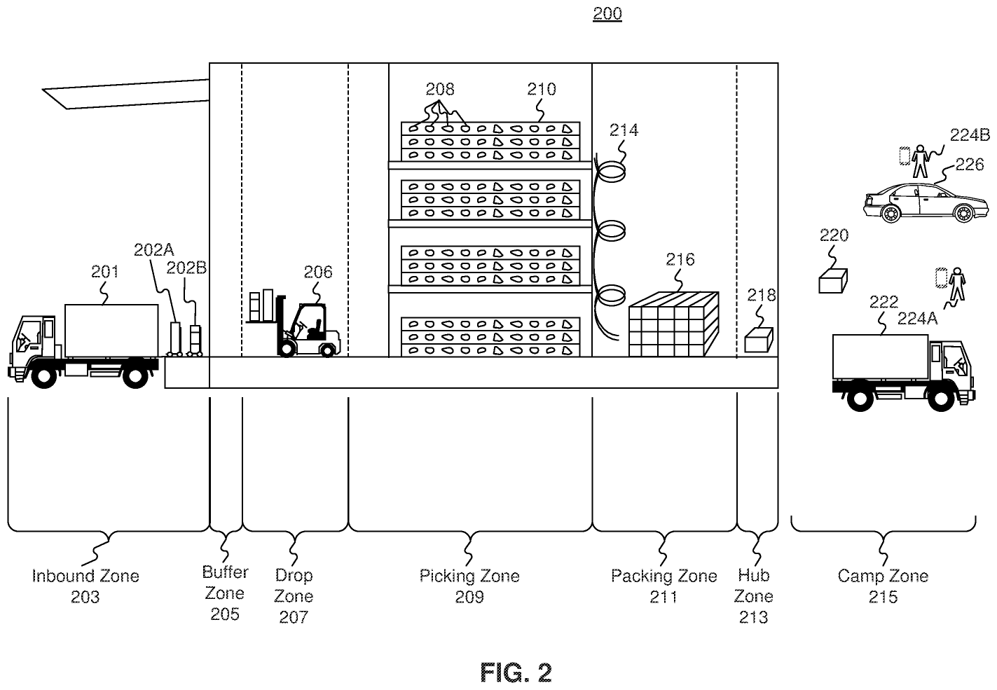

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3rd party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 119B.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

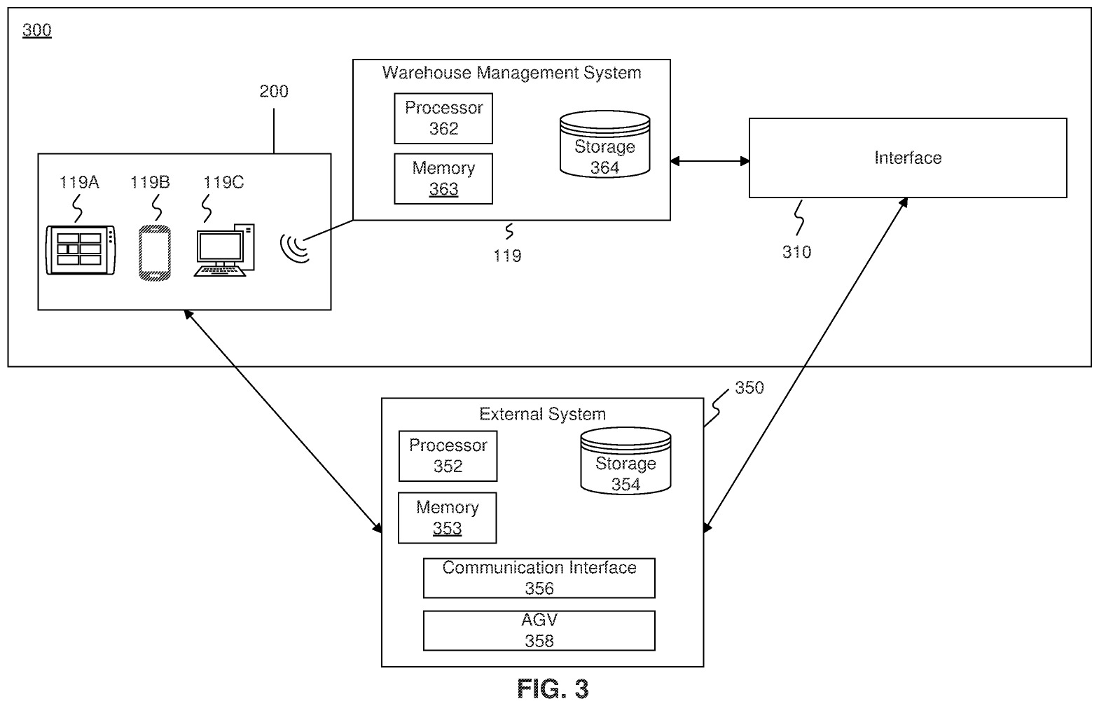

FIG. 3 is a schematic block diagram illustrating an exemplary embodiment of a network comprising computerized systems for product scrapping and product processing, consistent with the disclosed embodiments.

As shown in FIG. 3, a system 300 may include FC 200 (e.g., FC 200 of FIG. 1A, FIG. 2), WMS 119 (e.g., WMS 119 of FIG. 1A), and an interface 310 (e.g., middleware, application programming interface (API), web servers, hardware integration platform, automated robotics platform, etc.). In some embodiments, FC 200 may include mobile devices 119A, 119B, and 119C (e.g., mobile devices 119A, 119B, and 119C of FIG. 1A).

In some embodiments, mobile devices 119A, 119B, and 119C may be a tablet, mobile device, computer, or the like. Mobile devices 119A, 119B, and 119C may include a display. The display may include, for example, liquid crystal displays (LCD), light emitting diode screens (LED), organic light emitting diode screens (OLED), a touch screen, and other known display devices. The display may show various information to a user. For example, it may display a user interface element, which includes an option to scan an indicia (e.g., a barcode, an expiration date of a product or SKU, a manufacturing date of a product or SKU, an image, a text string, an RFID tag, or the like) of a product (e.g., items 202A or 202B of FIG. 2) or SKU during processor 400, 500 or 600. Mobile devices 119A, 119B, and 119C may include one or more input/output (I/O) devices. The I/O devices may include one or more devices that allow an operator to send and receive information from mobile devices 119A, 119B, and 119C or another device. The I/O devices may include various input/output devices, a camera, a microphone, a keyboard, a mouse-type device, a gesture sensor, an action sensor, a physical button, an oratory input, etc. The I/O devices may also include one or more communication modules (not shown) for sending and receiving information from system 300 by, for example, establishing wired or wireless connectivity between mobile devices 119A, 119B, or 119C and WMS 119, interface 310, or external system 350.

In some embodiments, WMS 119 may include a processor 362, a memory 363, and a data structure storage 364.

Processor 362 may be one or more known processing devices, such as a microprocessor from the Pentium™ family manufactured by Intel™ or the Turion™ family manufactured by AMD™. Processor 362 may constitute a single core or multiple core processor that executes parallel processes simultaneously. For example, processor 362 may use logical processors to simultaneously execute and control multiple processes. Processor 362 may implement virtual machine technologies or other known technologies to provide the ability to execute, control, run, manipulate, store, etc. multiple software processes, applications, programs, etc. In another example, processor 362 may include a multiple-core processor arrangement configured to provide parallel processing functionalities to allow WMS 119 to execute multiple processes simultaneously. One of ordinary skill in the art would understand that other types of processor arrangements could be implemented that provide for the capabilities disclosed herein.

Memory 363 may store one or more operating systems that perform known operating system functions when executed by processor 362. By way of example, the operating system may include Microsoft Windows, Unix, Linux, Android, Mac OS, iOS, or other types of operating systems. Accordingly, examples of the disclosed invention may operate and function with computer systems running any type of operating system. Memory 363 may be a volatile or non-volatile, magnetic, semiconductor, tape, optical, removable, non-removable, or other type of storage device or tangible computer readable medium.

Data structure storage 364 may include, for example, Oracle™ databases, Sybase™ databases, or other relational databases or non-relational databases, such as Hadoop™ sequence files, HBase™, or Cassandra™. Data structure storage 364 may include computing components (e.g., database management system, database server, etc.) configured to receive and process requests for data stored in memory devices of the database(s) and to provide data from the database(s). Data structure storage 364 may include NoSQL databases such as HBase, MongoDB™ or Cassandra™. Alternatively, data structure storage 364 may include relational databases such as Oracle, MySQL and Microsoft SQL Server. In some embodiments, data structure storage 364 may take the form of servers, general purpose computers, mainframe computers, or any combination of these components.

Data structure storage 364 may store data that may be used by processor 362, respectively, for performing methods and processes associated with disclosed examples. Data structure storage 364 may be located in WMS 119 as shown in FIG. 3, or alternatively, it may be in external storage devices located outside of WMS 119. Data stored in data structure storage 364 may include any suitable data associated with products or SKUs (e.g., SKU identifiers, product identifiers, expiration dates of products or SKUs, manufacturing dates of products or SKUs, sellable or unsellable status of products or SKUs, prices of products, discounted prices of products, inventory status of products or SKUs, etc.).

In some embodiments, WMS 119 may not manage the location of its products or SKUs in FC 200. That is, components of system 300 (e.g., WMS 119, interface 310, mobile devices 119A, 119B, or 119C, etc.) may be unable to determine any location identifiers associated with any SKUs in FC 200. In some embodiments, data storage structure 364 and data storage structure 354 are independent of each other (e.g., there is no communication link between these structures). Instead, WMS 119 may eliminate the need to maintain or track the location of different products or SKUs by offloading this role onto an external system 350. In some embodiments, WMS 119 may communicate with external system 350 via interface 310 (e.g., middleware).

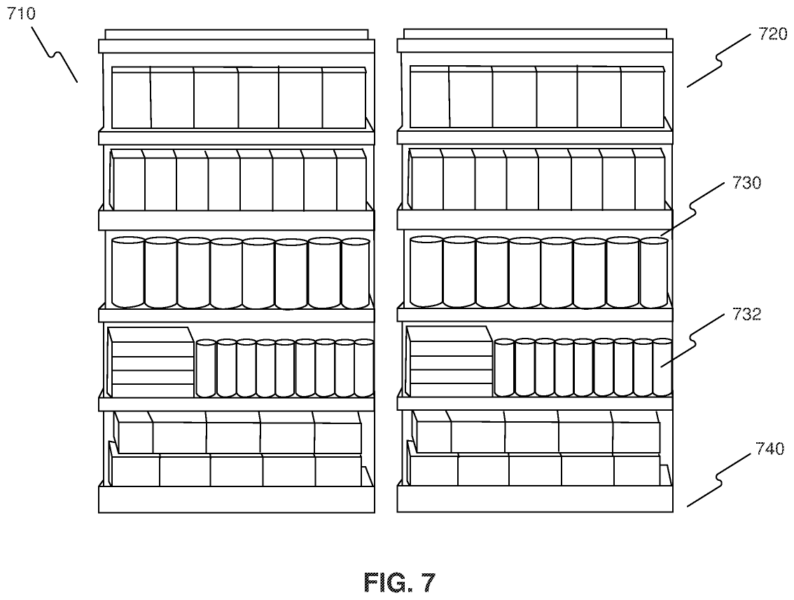

In some embodiments, external system 350 may include a processor 352, a memory 353, a data structure storage 354, a communication interface 356 (e.g., to communicate between external system 350 and interface 310), and at least one automated guided vehicle (AGV) (e.g., AGVs 710 or 720 of FIG. 7).

Processor 352 may be one or more known processing devices, such as a microprocessor from the Pentium™ family manufactured by Intel™ or the Turion™ family manufactured by AMD™. Processor 352 may constitute a single core or multiple core processor that executes parallel processes simultaneously. For example, processor 352 may use logical processors to simultaneously execute and control multiple processes. Processor 352 may implement virtual machine technologies or other known technologies to provide the ability to execute, control, run, manipulate, store, etc. multiple software processes, applications, programs, etc. In another example, processor 352 may include a multiple-core processor arrangement configured to provide parallel processing functionalities to allow one or more AGVs or other components of external system 350 to execute multiple processes simultaneously. One of ordinary skill in the art would understand that other types of processor arrangements could be implemented that provide for the capabilities disclosed herein.

Memory 353 may store one or more operating systems that perform known operating system functions when executed by processor 352. By way of example, the operating system may include Microsoft Windows, Unix, Linux, Android, Mac OS, iOS, or other types of operating systems. Accordingly, examples of the disclosed invention may operate and function with computer systems running any type of operating system. Memory 353 may be a volatile or non-volatile, magnetic, semiconductor, tape, optical, removable, non-removable, or other type of storage device or tangible computer readable medium.

Data structure storage 354 may include, for example, Oracle™ databases, Sybase™ databases, or other relational databases or non-relational databases, such as Hadoop™ sequence files, HBase™, or Cassandra™. Data structure storage 354 may include computing components (e.g., database management system, database server, etc.) configured to receive and process requests for data stored in memory devices of the database(s) and to provide data from the database(s). Data structure storage 354 may include NoSQL databases such as HBase, MongoDB™ or Cassandra™. Alternatively, data structure storage 354 may include relational databases such as Oracle, MySQL and Microsoft SQL Server. In some embodiments, data structure storage 354 may take the form of servers, general purpose computers, mainframe computers, or any combination of these components.

Data structure storage 354 may store data that may be used by processor 352, respectively, for performing methods and processes associated with disclosed examples. Data structure storage 354 may be located in external system 350 as shown in FIG. 3, or alternatively, it may be in external storage devices located outside of external system 350. Data stored in data structure storage 354 may include any suitable data associated with products or SKUs (e.g., SKU identifiers, product identifiers, expiration dates of products or SKUs, manufacturing dates of products or SKUs, sellable or unsellable status of products or SKUs, prices of products, discounted prices of products, inventory status of products or SKUs, etc.).

AGVs may include “shelves” or “bins” (e.g., shelves or bins 730 of FIG. 7) that may carry and transport one or more SKUs of products (e.g., products 732 of FIG. 7). AGVs may traverse a certain area or zone of FC 200 that is separate from the areas or zones occupied by operators or mobile devices 119A, 119B, and 119C. Advantageously, AGVs may transport various SKUs of products from storage in FC 200 to one or more terminals of FC 200, where operators or mobile devices may access the SKUs at these one or more terminals. That is, operators or mobile devices may remain stationary at one or more terminals while AGVs transport SKUs in FC 200 between storage units and terminals.

Advantageously, external system 350 may allow for more efficient storage of products or SKUs in FC 200 because the inventory does not need to be catalogued or stored in shelving in any particular manner that is accessible to operators. That is, throughput and efficiency of FC 200 may increase due to the fact that WMS 119 does not manage the location of its products or SKUs in FC 200.

In some embodiments, system 300 or components thereof (e.g., WMS 119, interface 310, mobile devices 119A-119C, or external system 350) may perform one or more steps of processes 400, 500, or 600 described below.

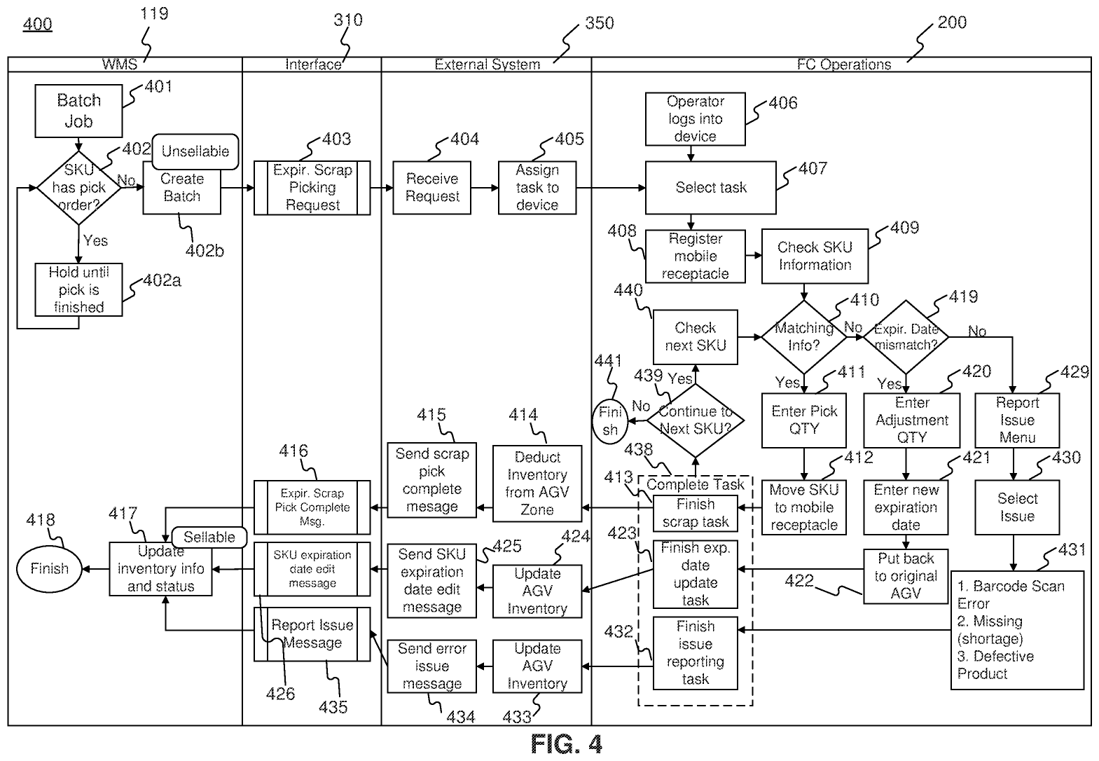

FIG. 4 is a diagram of a process 400 for product scrapping based on expiration dates, consistent with the disclosed embodiments.

At step 401, WMS 119 (e.g., WMS 119 of FIG. 1A, WMS 119 of FIG. 3, etc.) may initiate a request to create a batch job for scrapping SKUs of products that have expired. For example, WMS 119 may execute step 401 once every 24 hours, once every 12 hours, once every three calendar days, or at any other interval. WMS 119 may also execute step 401 manually (e.g., when prompted by a using a device such as mobile devices 119A-119C).

At step 402, WMS 119 may determine whether any SKUs in a FC have a pick order. In some embodiments, a pick order of a SKU is an order to retrieve (e.g., “pick”) the SKU (e.g., to evaluate the SKU or its products, to scrap the SKU or its products, to sell the SKU or its products, because a customer is purchasing a product from the SKU, etc.).

At step 402a, if any SKUs in a FC have a pick order, then WMS 119 may hold off from (e.g., refrain from) creating a batch job for scrapping that SKU.

At step 402b, for the SKUs that do not have a pick order, WMS 119 may create a batch job for scrapping those SKUs (e.g., scrapping the “unsellable” SKUs). In some embodiments, WMS 119 may create a batch job by generating a list of SKUs, where each SKU includes at least one product (e.g., products with an expiration date, such as meat) and a registered SKU identifier. In some embodiments, the registered SKU identifier may be stored in a data structure (e.g., data structure storage 364 of FIG. 3) of WMS 119. In some embodiments, the registered SKU identifier may indicate a quantity of products in the SKU, an expiration date corresponding to the earliest expiration date of a product in the SKU, a shelf date of the SKU, a time span within which customers may safely consume a product in the SKU, etc. In some embodiments, a SKU may include a plurality of the same products, where some products may different expiration dates. In some embodiments, a SKU may have products that all have the same expiration date.

In some embodiments, generating a list of SKUs may include determining a product identifier (e.g., product name, product quantity, product expiration date, product shelf date, etc.) of at least one product of the SKU. In some embodiments, WMS 119 may compare each product identifier of a SKU to a threshold range and when the product identifier is within the threshold range, WMS 119 may retrieve the corresponding SKU to be included in the generated list. In some embodiments, the product identifier may be an expiration date of the at least one product and the threshold range may span from a current date (e.g., the date on which WMS 119 creates the corresponding batch) to earlier than the current date.

In some embodiments, WMS 119 may transmit the generated list of SKUs to interface 310 (e.g., interface 310 of FIG. 3).

At step 403, interface 310 (e.g., interface 310 of FIG. 3) may receive the generated list of SKUs from WMS 119. In response to receiving the generated list of SKUs, interface 310 may generate an expired scrap picking request and a request to determine the location identifier (e.g., coordinates, location index, etc. associated with a SKU's location in a FC) associated with each SKU of the plurality of SKUs on the list.

In some embodiments, interface 310 may convert the request into a request specific to external system 350 and transmit the request to determine the location identifiers associated with the plurality of SKUs to external system 350 (e.g., external system 350 of FIG. 3). In some embodiments, external system 350 may be one of a plurality of types of external systems, and interface 310 may be configured to convert incoming requests to a format associated with any of those systems.

At step 404, external system 350 may receive the request transmitted by interface 310.

At step 405, in response to receiving the request, external system 350 may assign a task associated with the generated list of SKUs to at least one operator associated with a user device (e.g., mobile devices 119A, 119B, and 119C of FIG. 1A) and the at least one terminal of FC 200. In some embodiments, external system 350 may assign a task to at least one operator automatically based on a log of different batches generated by WMS 119. In some embodiments, at least one operator may be assigned a task based at least one of their availability, location, etc. In some embodiments, external system 350 may assign a task to a plurality of operators for a single batch. In some embodiments, external system 350 may assign a task to at least one operator by generating an interface to be displayed on a user device, where at least one operator may be assigned a task by selecting at least one SKU or batch job by interacting with the interface. In some embodiments, external system 350 may assign a task to at least one operator when an operator logs into their associated user device (see, e.g., step 406 below). In some embodiments, external system 350 may transmit an indication of the assigned task to at least one user device of FC 200.

In some embodiments, at least one operator may be associated with at least one terminal in FC 200. In some embodiments, an operator may be assigned to a terminal in FC 200 when they log into their associated user device (see, e.g., step 406 below). In some embodiments, in response to receiving the request, external system 350 may determine the location identifier associated with each SKU of the plurality of SKUs and command at least one AGV (e.g., AGVs 710 or 720 of FIG. 7) to retrieve each SKU. In some embodiments, external system 350 may command one or more AGVs to retrieve each SKU by calculating, based on the one or more AGVs, an optimal combination of AGVs and transport paths for the one or more AGVs. For example, one AGV may retrieve SKUs for different batch jobs on a single retrieving trip, thereby increasing efficiency and throughput in FC 200. In some embodiments, external system may calculate an optimal combination of AGVs and transport paths by optimizing the efficiency and throughput of FC 200 based on the size of the SKUs, density of the SKUs, location of the SKUs, etc. External system 350 may transport, by the AGV, each SKU to at least one terminal of FC 200.

At step 406, at least one operator of the assigned task may log into their associated user device.

At step 407, at least one user device of FC 200 may select and initiate the assigned task. In some embodiments, a system of FC 200 may cause a user device to display an instruction for selecting and initiating the assigned task.

At step 408, at least one user device may register a mobile receptacle (e.g., a mobile tote) with the assigned task. For example, at least one user device may associate an identifier of the mobile receptacle with the assigned task. In some embodiments, a system of FC 200 may cause a user device to display an instruction for performing this step.

At step 409, at least one operator of the assigned task may compare, by a user device associated with a terminal, the registered SKU identifier with a physical SKU identifier of a SKU at the terminal. Similar to the registered SKU identifier, the physical SKU identifier may indicate a quantity of products in the SKU, an expiration date corresponding to the earliest expiration date of a product in the SKU, a shelf date of the SKU, a time span within which customers may safely consume a product in the SKU, etc. In some embodiments, the physical SKU identifier may be affixed to a SKU.

At step 410, an operator may determine whether the registered SKU identifier and the physical SKU identifier are consistent with each other (e.g., whether the identifiers match each other).

When the registered SKU identifier is consistent with the physical SKU identifier, then at step 411, a user device may enter a pick quantity of the number of products associated with the SKU under evaluation. In some embodiments, a system of FC 200 may cause a user device to display an instruction for performing this step. The pick quantity may indicate to an operator the number of products that need to be transferred from the SKU to the registered mobile receptacle to undergo a scrapping process.

At step 412, an operator may transfer the SKU to the registered mobile receptacle.

At step 413, WMS 119 may finish the scrap task by transporting, by the mobile receptacle, the corresponding SKU to an area of FC 200 to undergo a scrapping process. For example, the scrapping process may include transporting, by the mobile receptacle, the corresponding SKU to an area of FC 200 to be physically disposed of from FC 200. A user device of FC 200 may transmit an indication of the finished scrap task to external system 350.

At step 414, in response to receiving an indication of the finished scrap task from FC 200, external system 350 may modify a data structure (e.g., data structure storage 354 of FIG. 3) to deduct the corresponding SKU from the data structure. That is, external system 350 may deduct from the inventory of its data structure in communication with at least one AGV in an AGV zone of FC 200.

At step 415, external system 350 may transmit a scrap pick complete message to interface 310 to indicate that the scrapping process is complete.

At step 416, interface 310 may generate an expired scrap pick complete message in response to receiving a scrap pick complete message from external system 350. Interface 310 may transmit the expired scrap pick complete message, or a message based on the received expired scrap pick complete message, to WMS 119.

At step 417, WMS 119 may update its inventory information and status in response to receiving an expired scrap pick complete message from interface 310. For example, WMS 119 may update its inventory information and status by modifying the registered SKU identifier of the corresponding scrapped SKU to indicate it is not sellable and modify a data structure of WMS 119 to deduct the corresponding SKU from the data structure.

At step 418, WMS 119 may finish or complete the process described above.

Turning back to step 410, when the registered SKU identifier is inconsistent with the physical SKU identifier, then a user device of FC 200 may perform logic steps to assess the corresponding SKU. For example, at step 419, a user device may determine whether the inconsistency is between the expiration date of the registered SKU identifier and the expiration date of the physical SKU identifier.

When the inconsistency between the registered SKU identifier and the physical SKU identifier is the expiration dates of the registered SKU identifier and the physical SKU identifier, at step 420 a user device of FC 200 may enter an adjustment quantity. In some embodiments, a system of FC 200 may cause a user device to display an instruction for performing this step. For example, if the expiration date of the registered SKU identifier is 3 days earlier than the expiration date of the physical SKU identifier, then a user device of FC 200 may enter an adjustment quantity of 3 days.

At step 421, a user device of FC 200 may enter a new expiration date of the corresponding SKU according to the adjustment quantity determined in step 420. In some embodiments, a system of FC 200 may cause a user device to display an instruction for performing this step.

At step 422, an operator may put the corresponding SKU back into its original AGV at the corresponding terminal.

At step 423, a user device may finish the expiration date update task by transmitting, by a user device of FC 200, an indication of the finished expiration date update task to external system 350.

At step 424, in response to receiving an indication of the finished expiration date update task from FC 200, external system 350 may command an AGV to transport the corresponding SKU to an area of FC 200 to store to be sold. In some embodiments, the AGV may transport the corresponding SKU to its original location in FC 200 (e.g., before process 400 commenced). In some embodiments, the AGV may transport the corresponding SKU to another location of FC 200 (e.g., based on its updated expiration date

External system 350 may modify a data structure to update the expiration date of the corresponding SKU. That is, external system 350 may update an expiration date of the inventory of its data structure in communication with at least one AGV in an AGV zone of FC 200.

At step 425, external system 350 may transmit a SKU expiration date edit message to interface 310 to indicate that the expiration date edit process is complete.

At step 426, interface 310 may generate an SKU expiration edit message in response to receiving a SKU expiration date edit message from external system 350. Interface 310 may transmit the SKU expiration edit message, or a message based on the received SKU expiration date edit message, to WMS 119.

At step 417, WMS 119 may update its inventory information and status in response to receiving a SKU expiration edit message from interface 310. For example, WMS 119 may update its inventory information and status by modifying the registered SKU identifier of the corresponding SKU to update its expiration date according to the results of the performed logic steps. For example, WMS 119 may modify the registered SKU identifier to be the expiration date of the physical SKU identifier.

At step 418, WMS 119 may finish or complete the process described above.

Turning back to step 419, when the inconsistency between the registered SKU identifier and the physical SKU identifier is not the expiration dates of the registered SKU identifier and the physical SKU identifier, at step 429 a user device of FC 200 may generate a report issue menu. For example, if the expiration date of the registered SKU identifier matches the expiration date of the physical SKU identifier, then a user device of FC 200 may generate a report issue menu for display to an operator.

At step 430, a user device may generate a select issue interface for display to an operator. In some embodiments, the generated select issue interface may be displayed on an interface of any device or system (e.g., of system 300 of FIG. 3).

At step 431, a user device (e.g., automatically) may determine the type of inconsistency between the registered SKU identifier and the physical SKU identifier. For example, the inconsistency may be a barcode scan error of the physical SKU (e.g., a user device may be unable to read a barcode of the SKU), a missing error (e.g., a user device may determine that at least one product is missing from the SKU), or a defective product error (e.g., a user device may determine that at least one product of the SKU is defective or damaged).

At step 432, WMS 119 may finish the issue reporting task by transmitting, by a user device of FC 200, an indication of the finished issue reporting task to external system 350.

At step 433, in response to receiving an indication of the finished issue reporting task from FC 200, external system 350 may command an AGV to transport the corresponding SKU to a “problem zone” area of FC 200 to store (e.g., temporarily or permanently) without being for sale. In some embodiments, the AGV may transport the corresponding SKU to its original location in FC 200 (e.g., before process 400 commenced). In some embodiments, the AGV may transport the corresponding SKU to another location of FC 200 (e.g., based on its updated expiration date).

External system 350 may modify a data structure (e.g., FIG. 3) to deduct the corresponding SKU from the data structure while the SKU is in the problem zone area of FC 200. That is, external system 350 may deduct from the inventory of its data structure in communication with at least one AGV in an AGV zone of FC 200.

At step 434, external system 350 may transmit an error issue message to interface 310 to indicate that the issue reporting process is complete.

At step 435, interface 310 may generate a report issue message in response to receiving an error issue message from external system 350. Interface 310 may transmit the error issue message, or a message based on the received error issue message, to WMS 119.

At step 417, WMS 119 may update its inventory information and status in response to receiving an error issue message from interface 310. For example, WMS 119 may update its inventory information and status by modifying the registered SKU identifier of the corresponding SKU to indicate it is not sellable and modify a data structure of WMS 119 to deduct the corresponding SKU from the data structure.

At step 418, WMS 119 may finish or complete the process described above.

Turning to step 438, after any one of steps 413, 423, or 432, a user device of FC 200 may proceed to step 439 to determine whether another SKU needs to be evaluated.

If another SKU needs to be evaluated, then at step 440 a user device may check the next SKU that needs to be evaluated and proceed to step 410, repeating the process steps described above.

If another SKU does not need to be evaluated, then at step 441 a user device in FC 200 may complete the process described above.

It should be understood that a plurality of SKUs may undergo process 400 substantially simultaneously. For example, a SKU may undergo one or more steps of process 400 while another SKU of another batch undergoes one or more steps of process 400.

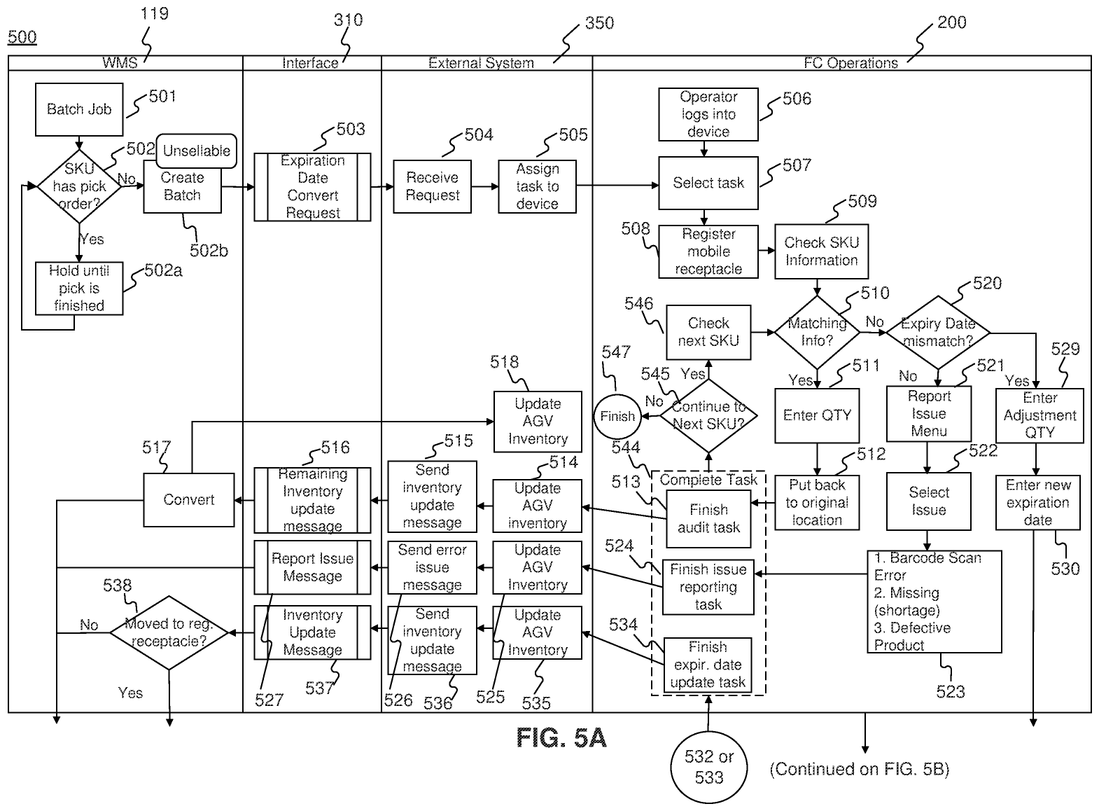

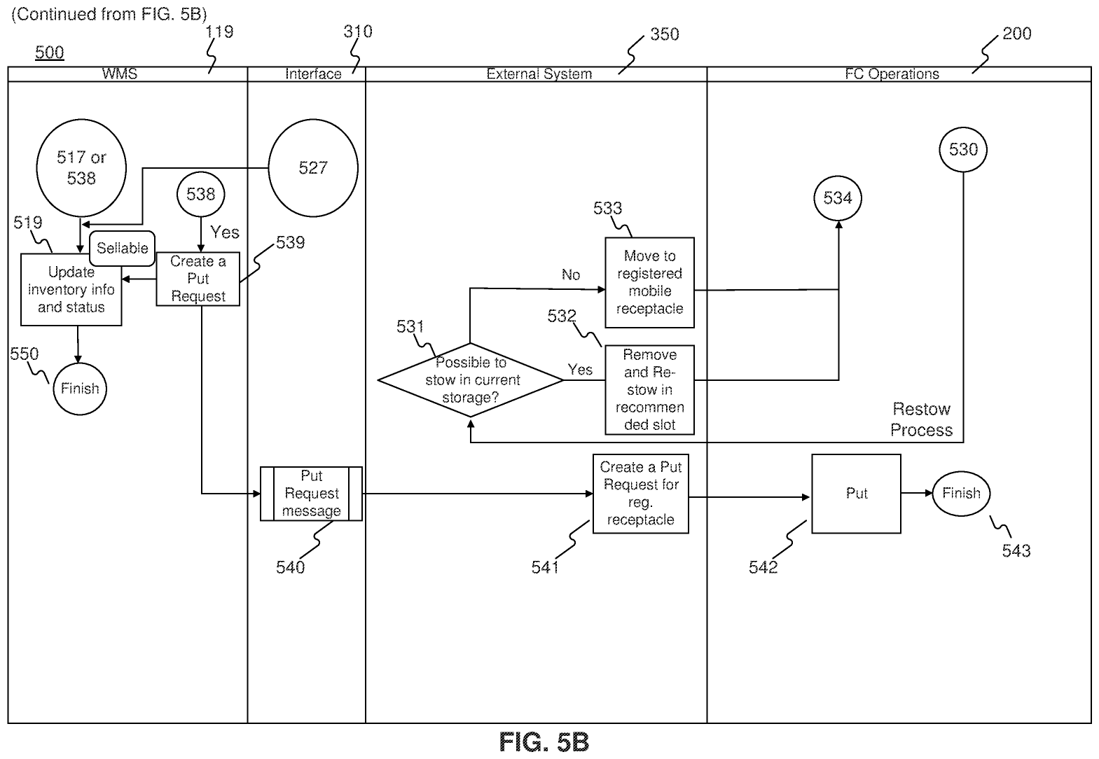

FIG. 5A is a diagram of a process 500 for product conversion based on expiration dates, consistent with the disclosed embodiments.

At step 501, WMS 119 (e.g., WMS 119 of FIG. 1A, WMS 119 of FIG. 3, etc.) may initiate a request to create a batch job for converting SKUs of products, based on their expiration dates, that are still sellable. For example, WMS 119 may execute step 501 once every 24 hours, once every 12 hours, once every three calendar days, or at any other interval. WMS 119 may also execute step 501 manually (e.g., when prompted by a using a device such as mobile devices 119A-119C).

At step 502, WMS 119 may determine whether any SKUs in a FC have a pick order. In some embodiments, a pick order of a SKU is an order to retrieve (e.g., “pick”) the SKU (e.g., to evaluate the SKU or its products, to scrap the SKU or its products, to convert the SKU or its products, to sell the SKU or its products, because a customer is purchasing a product from the SKU, etc.).

At step 502a, if any SKUs in a FC have a pick order, then WMS 119 may hold off from (e.g., refrain from) creating a batch job for converting that SKU.

At step 502b, for the SKUs that do not have a pick order, WMS 119 may create a batch job for converting those SKUs (e.g., converting the SKUs that are still sellable into SKUs with discounted prices). In some embodiments, WMS 119 may create a batch job by generating a list of SKUs, where each SKU includes at least one product (e.g., products with an expiration date, such as meat) and a registered SKU identifier. In some embodiments, the registered SKU identifier may be stored in a data structure (e.g., data structure storage 364 of FIG. 3) of WMS 119. In some embodiments, the registered SKU identifier may indicate a quantity of products in the SKU, an expiration date corresponding to the earliest expiration date of a product in the SKU, a shelf date of the SKU, a time span within which customers may safely consume a product in the SKU, etc. In some embodiments, a SKU may include a plurality of the same products, where some products may different expiration dates. In some embodiments, a SKU may have products that all have the same expiration date.

In some embodiments, generating a list of SKUs may include determining a product identifier (e.g., product name, product quantity, product expiration date, product shelf date, etc.) of at least one product of the SKU. In some embodiments, WMS 119 may compare each product identifier of a SKU to a threshold range and when the product identifier is within the threshold range, WMS 119 may retrieve the corresponding SKU to be included in the generated list. In some embodiments, the product identifier may be an expiration date of the at least one product and the threshold range may span a time period after a current date (e.g., a time period after the date on which WMS 119 creates the corresponding batch). For example, the threshold range may be a time period in which products of a SKU have not expired yet and are still sellable, but should be sold at a discounted price to increase throughput of purchase orders and profitability of products in a FC.

In some embodiments, WMS 119 may transmit the generated list of SKUs to interface 310 (e.g., interface 310 of FIG. 3).

At step 503, interface 310 (e.g., interface 310 of FIG. 3) may receive the generated list of SKUs from WMS 119. In response to receiving the generated list of SKUs, interface 310 may generate an expiration date conversion request and generate a request to determine the location identifier (e.g., coordinates, location index, etc. associated with a SKU's location in a FC) associated with each SKU of the plurality of SKUs on the list.

In some embodiments, interface 310 may convert the request into a request specific to external system 350 and transmit the request to determine the location identifiers associated with the plurality of SKUs to external system 350 (e.g., external system 350 of FIG. 3). In some embodiments, external system 350 may be one of a plurality of types of external systems, and interface 310 may be configured to convert incoming requests to a format associated with any of those systems.

At step 504, external system 350 may receive the request transmitted by interface 310.

At step 505, in response to receiving the request, external system 350 may assign a task associated with the generated list of SKUs to at least one operator associated with a user device (e.g., mobile devices 119A, 119B, and 119C of FIG. 1A) and the at least one terminal of FC 200. In some embodiments, external system 350 may assign a task to at least one operator automatically based on a log of different batches generated by WMS 119. In some embodiments, at least one operator may be assigned a task based at least one of their availability, location, etc. In some embodiments, external system 350 may assign a task to a plurality of operators for a single batch. In some embodiments, external system 350 may assign a task to at least one operator by generating an interface to be displayed on a user device, where at least one operator may be assigned a task by selecting at least one SKU or batch job by interacting with the interface. In some embodiments, external system 350 may assign a task to at least one operator when an operator logs into their associated user device (see, e.g., step 506 below). In some embodiments, external system 350 may transmit an indication of the assigned task to at least one user device of FC 200.

In some embodiments, at least one operator may be associated with at least one terminal in FC 200. In some embodiments, an operator may be assigned to a terminal in FC 200 when they log into their associated user device (see, e.g., step 506 below). In some embodiments, in response to receiving the request, external system 350 may determine the location identifier associated with each SKU of the plurality of SKUs and command at least one AGV (e.g., AGVs 710 or 720 of FIG. 7) to retrieve each SKU. In some embodiments, external system 350 may command one or more AGVs to retrieve each SKU by calculating, based on the one or more AGVs, an optimal combination of AGVs and transport paths for the one or more AGVs. For example, one AGV may retrieve SKUs for different batch jobs on a single retrieving trip, thereby increasing efficiency and throughput in FC 200. In some embodiments, external system may calculate an optimal combination of AGVs and transport paths by optimizing the efficiency and throughput of FC 200 based on the size of the SKUs, density of the SKUs, location of the SKUs, etc. External system 350 may transport, by the AGV, each SKU to at least one terminal of FC 200.

At step 506, at least one operator of the assigned task may log into their associated user device.

At step 507, at least one user device of FC 200 may select and initiate the assigned task. In some embodiments, a system of FC 200 may cause a user device to display an instruction for performing this step.

At step 508, at least one user device may register a mobile receptacle (e.g., a mobile tote) with the assigned task. For example, at least one user device may associate an identifier of the mobile receptacle with the assigned task. In some embodiments, a system of FC 200 may cause a user device to display an instruction for performing this step.

At step 509, at least one operator of the assigned task may compare, by a user device associated with a terminal, the registered SKU identifier with a physical SKU identifier of a SKU at the terminal. Similar to the registered SKU identifier, the physical SKU identifier may indicate a quantity of products in the SKU, an expiration date corresponding to the earliest expiration date of a product in the SKU, a shelf date of the SKU, a time span within which customers may safely consume a product in the SKU, etc. In some embodiments, the physical SKU identifier may be affixed to a SKU.

At step 510, an operator may determine whether the registered SKU identifier and the physical SKU identifier are consistent with each other (e.g., whether the identifiers match each other).

When the registered SKU identifier is consistent with the physical SKU identifier, then at step 511, a user device may enter a pick quantity of the number of products associated with the SKU under evaluation. In some embodiments, a system of FC 200 may cause a user device to display an instruction for performing this step. The pick quantity may indicate to an operator the number of products that need to be transferred from the SKU to the AGV to undergo a conversion process, which includes returning the products to their original location in FC 200 to be sold at a discounted price.

At step 512, an operator may transfer the SKU to the AGV.

At step 513, WMS 119 may finish the audit task of the SKU by transporting, by the AGV, the corresponding SKU to its original location in FC 200 to be stored and to under a conversion process. A user device of FC 200 may transmit an indication of the finished audit task to external system 350.

At step 514, in response to receiving an indication of the finished audit task from FC 200, external system 350 may modify a data structure (e.g., data structure storage 354 of FIG. 3) to indicate that the corresponding SKU is to be converted into a SKU with a discounted price. That is, external system 350 may update the inventory of its data structure in communication with at least one AGV in an AGV zone of FC 200. For example, external system 350 may modify its data structure to update the registered SKU identifier of the corresponding SKU to indicate it is to undergo a conversion process.

At step 515, external system 350 may transmit a send inventory update message to interface 310 to indicate that the inventory update of the corresponding SKU is complete.

At step 516, interface 310 may generate a remaining inventory update message in response to receiving a send inventory update message from external system 350. Interface 310 may transmit the remaining inventory update message, or a message based on the received send inventory update message, to WMS 119.

At step 517, WMS 119 may convert the corresponding SKU into a SKU with a discounted price. The conversion process may include calculating a discount value of the corresponding SKU based on the registered SKU identifier, modifying the registered SKU identifier of the corresponding SKU to apply the calculated discount value, and modifying the registered SKU identifier of the corresponding SKU to indicate it is sellable. In some embodiments, WMS 119 may calculate a discount value of the corresponding SKU based on the time span between a current date and an expiration date of the corresponding SKU (e.g., the discount value may be higher if the time span between the current date and the expiration date is lower; the discount value may be lower if the time span between the current date and the expiration date is higher; etc.).

In some embodiments, WMS 119 may calculate a discount value of the corresponding SKU based on the type of products in the SKU (e.g., products that have a shorter time period to safely consume may have a higher discount than products that have a longer time period to safely consume). In some embodiments, WMS 119 may calculate a discount value using different standards for different SKU categories (e.g., the discount for a first category of SKUs may be calculated using a first standard while the discount for a second category of SKUs may be calculated using a second standard). In some embodiments, a minimum discount may be applied to a SKU based on the category of SKU. In some embodiments, WMS 119 may calculate a discount for a SKU that already has a discounted price according to a standard that is different from calculating a discount for a SKU that does not have a discounted price (e.g., it has its original price). In some embodiments, WMS 119 may calculate a discount value based on the shelf life of a SKU. In some embodiments, WMS 119 may apply more discounts to a SKU as more time passes without the SKU being sold.

At step 518, in response to WMS 119 converting the corresponding SKU, external system 350 may modify its data structure to indicate that the corresponding SKU has been converted into a SKU with a discounted price. External system 350 may update the inventory of its data structure in communication with at least one AGV in an AGV zone of FC 200. For example, external system 350 may modify its data structure to update the registered SKU identifier of the corresponding SKU to indicate it has undergone a conversion process and to modify its price to the converted price.

FIG. 5B is a diagram of a continuation from FIG. 5A of process 500 for product conversion based on expiration dates, consistent with the disclosed embodiments.

From step 517 of FIG. 5A, WMS 119 may proceed to step 519 of FIG. 5B. At step 519, in response to WMS 119 converting the corresponding SKU, WMS 119 may update its inventory information and status. For example, WMS 119 may update its inventory information and status by modifying the registered SKU identifier of the corresponding SKU to indicate it has undergone a conversion process, modifying the registered SKU identifier to modify its price to the converted price, modifying the registered SKU identifier to indicate it is sellable at the discounted price, and modifying a data structure of WMS 119 to indicate the price and sellable status of the corresponding SKU. WMS 119 may release any holds on the corresponding SKU so that products of the SKU may be sold to customers.

At step 550, WMS 119 may finish or complete the process described above.

Turning back to step 510 of FIG. 5A, when the registered SKU identifier is inconsistent with the physical SKU identifier, then a user device of FC 200 may perform logic steps to assess the corresponding SKU. For example, at step 520, a user device may determine whether the inconsistency is between the expiration date of the registered SKU identifier and the expiration date of the physical SKU identifier.

When the inconsistency between the registered SKU identifier and the physical SKU identifier is the expiration dates of the registered SKU identifier and the physical SKU identifier, at step 529 a user device of FC 200 may enter an adjustment quantity. In some embodiments, a system of FC 200 may cause a user device to display an instruction for performing this step. For example, if the expiration date of the registered SKU identifier is 7 days earlier than the expiration date of the physical SKU identifier, then a user device of FC 200 may enter an adjustment quantity of 7 days. In some embodiments, when the physical SKU identifier indicates an expiration date that is later than the registered SKU identifier by a certain threshold, a user device may determine that the corresponding SKU does not need to undergo a conversion process (e.g., the corresponding SKU should be sold at its current undiscounted price).

At step 530, a user device of FC 200 may enter a new expiration date of the corresponding SKU according to the adjustment quantity determined in step 420. In some embodiments, a system of FC 200 may cause a user device to display an instruction for performing this step. In some embodiments, WMS 119 may initiate a restow process.

Turning to step 531 of FIG. 5B, external system 350 may determine whether it is possible to stow the corresponding SKU in a current (e.g., original) storage unit.

If it is possible to stow the corresponding SKU in a current storage unit, then at step 532, external system 350 may determine that the corresponding SKU must be removed from the AGV and re-stowed in a recommended slot of the current storage unit. For example, external system 350 may increase the efficiency of process 500 and the throughput of process 500 by determining the optimum slot of the storage unit for the SKU. For example, external system 350 may determine the recommended slot of a storage unit based on the expiration dates of the corresponding SKU and the SKUs in the current storage unit or based on the types of products in the corresponding SKU and the SKUs in the current storage unit. For example, SKUs with similar or the same expiration dates may be stored in the same slot of the storage unit. In some embodiments, SKUs with similar or the same products may be stored in the same slot of the storage unit.

Turning back to step 531, if it is not possible to stow the corresponding SKU in a current storage unit (e.g., the current storage unit may not have any available space), then at step 533, external system 350 may command an AGV to transport the corresponding SKU into a registered mobile receptacle.

From step 532 or step 533, process 500 may proceed to step 534 of FIG. 5A.

At step 534, WMS 119 may finish the expiration date update task by transmitting, by a user device of FC 200, an indication of the finished expiration date update task to external system 350.

At step 535, in response to receiving an indication of the finished expiration date update task from FC 200, external system 350 may modify a data structure to update the expiration date of the corresponding SKU. That is, external system 350 may update an expiration date of the inventory of its data structure in communication with at least one AGV in an AGV zone of FC 200.

At step 536, external system 350 may transmit an inventory update message to interface 310 to indicate that the expiration date update process is complete.

At step 537, interface 310 may generate an inventory update message in response to receiving an inventory update message from external system 350. Interface 310 may transmit the inventory update message, or a message based on the received inventory update message, to WMS 119.

At step 538, WMS 119 may determine whether the corresponding SKU was transferred to a registered tote.

If the corresponding SKU was not transferred to a registered tote, then at step 519 of FIG. 5B, WMS 119 may update its inventory information and status. For example, WMS 119 may update its inventory information and status by modifying the registered SKU identifier of the corresponding SKU to update its expiration date according to the results of the performed logic steps. For example, WMS 119 may modify the registered SKU identifier to be the expiration date of the physical SKU identifier.

At step 550, WMS 119 may finish or complete the process described above.

Turning back to step 538 of FIG. 5A, if the corresponding SKU was transferred to a registered mobile receptacle, then at step 539 of FIG. 5B, WMS 119 may create a “put” request. For example, the put request may be a request to put the corresponding SKU in a current storage unit. WMS 119 may transmit the put request to interface 310. From step 539, process 500 may proceed to step 519 and step 540.

At step 540, in response to receiving the put request from WMS 119, interface 310 may generate a put request message indicating that the corresponding SKU must be put in a current storage unit. Interface 310 may transmit the put request message, or a message based on the received put request, to external system 350.

At step 541, external system 350 may generate a put request for a registered mobile receptacle and command a registered mobile receptacle to transport to a terminal of FC 200.

At step 542, a user device of FC 200 may put the corresponding SKU into the registered mobile receptacle to be re-stowed in a recommended slot of the current storage unit. In some embodiments, a system of FC 200 may cause a user device to display an instruction for putting the corresponding SKU into the registered mobile receptacle to be re-stowed in a recommended slot of the current storage unit.

At step 543, a user device of FC 200 may finish or complete the process described above.

Turning back to step 520 of FIG. 5A, when the inconsistency between the registered SKU identifier and the physical SKU identifier is not the expiration dates of the registered SKU identifier and the physical SKU identifier, at step 521 a user device of FC 200 may generate a report issue menu. For example, if the expiration date of the registered SKU identifier matches the expiration date of the physical SKU identifier, then a user device of FC 200 may generate a report issue menu for display to an operator.

At step 522, a user device may generate a select issue interface for display to an operator. In some embodiments, the generated select issue interface may be displayed on an interface of any device or system (e.g., of system 300 of FIG. 3).

At step 523, a user device (e.g., automatically) may determine the type of inconsistency between the registered SKU identifier and the physical SKU identifier. For example, the inconsistency may be a barcode scan error of the physical SKU (e.g., a user device may be unable to read a barcode of the SKU), a missing error (e.g., a user device may determine that at least one product is missing from the SKU), or a defective product error (e.g., a user device may determine that at least one product of the SKU is defective or damaged).

At step 524, WMS 119 may finish the issue reporting task by transmitting, by a user device of FC 200, an indication of the finished issue reporting task to external system 350.

At step 525, in response to receiving an indication of the finished issue reporting task from FC 200, external system 350 may command an AGV to transport the corresponding SKU to a “problem zone” area of FC 200 to store (e.g., temporarily or permanently) without being for sale. In some embodiments, the AGV may transport the corresponding SKU to its original location in FC 200 (e.g., before process 500 commenced). In some embodiments, the AGV may transport the corresponding SKU to another location of FC 200 (e.g., based on its updated expiration date).

External system 350 may modify a data structure to deduct the corresponding SKU from the data structure while the SKU is in the problem zone area of FC 200. That is, external system 350 may deduct from the inventory of its data structure in communication with at least one AGV in an AGV zone of FC 200.

At step 526, external system 350 may transmit an error issue message to interface 310 to indicate that the issue reporting process is complete.

At step 527, interface 310 may generate a report issue message in response to receiving an error issue message from external system 350. Interface 310 may transmit the error issue message, or a message based on the received error issue message, to WMS 119.

At step 519 of FIG. 5B, WMS 119 may update its inventory information and status in response to receiving an error issue message from interface 310. For example, WMS 119 may update its inventory information and status by modifying the registered SKU identifier of the corresponding SKU to indicate it is not sellable and modify a data structure of WMS 119 to deduct the corresponding SKU from the data structure.

At step 550, WMS 119 may finish or complete the process described above.

Turning to step 544, after any one of steps 513, 524, or 534, a user device of FC 200 may proceed to step 545 to determine whether another SKU needs to be evaluated.

If another SKU needs to be evaluated, then at step 546 a user device may check the next SKU that needs to be evaluated and proceed to step 510, repeating the process steps described above.

If another SKU does not need to be evaluated, then at step 547 a user device in FC 200 may complete the process described above.

It should be understood that a plurality of SKUs may undergo process 500 substantially simultaneously. For example, a SKU may undergo one or more steps of process 500 while another SKU of another batch undergoes one or more steps of process 500.

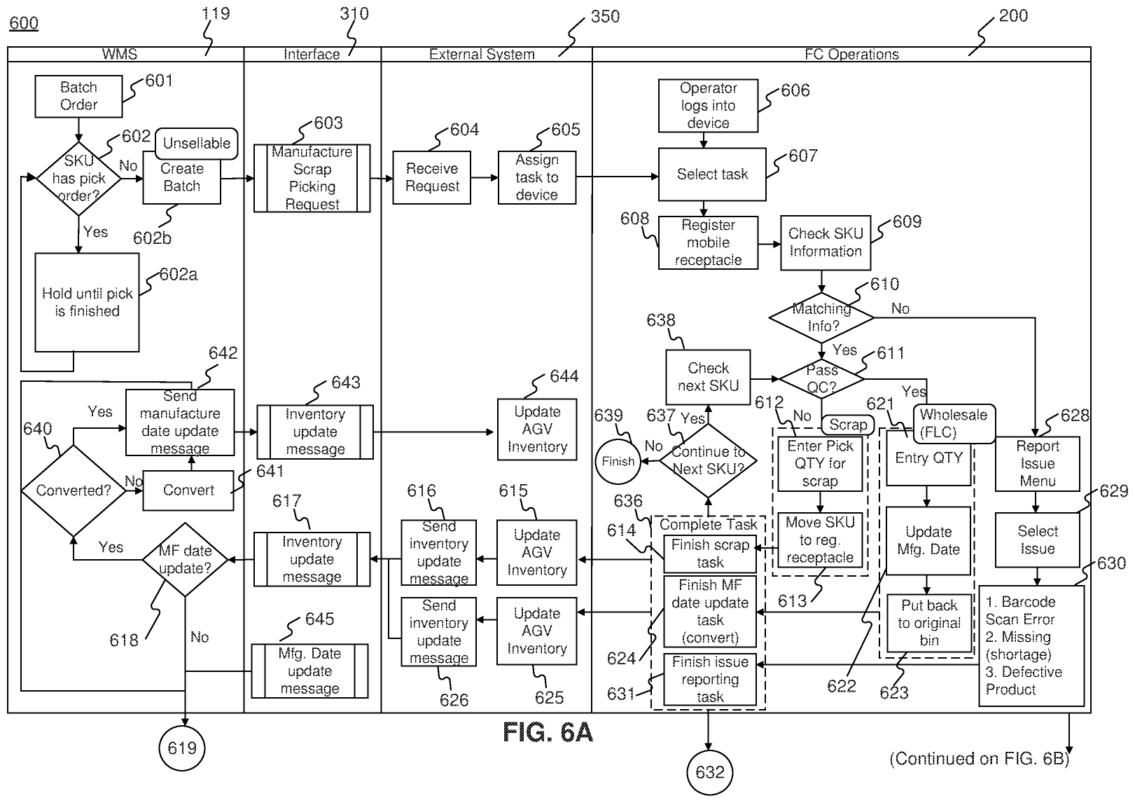

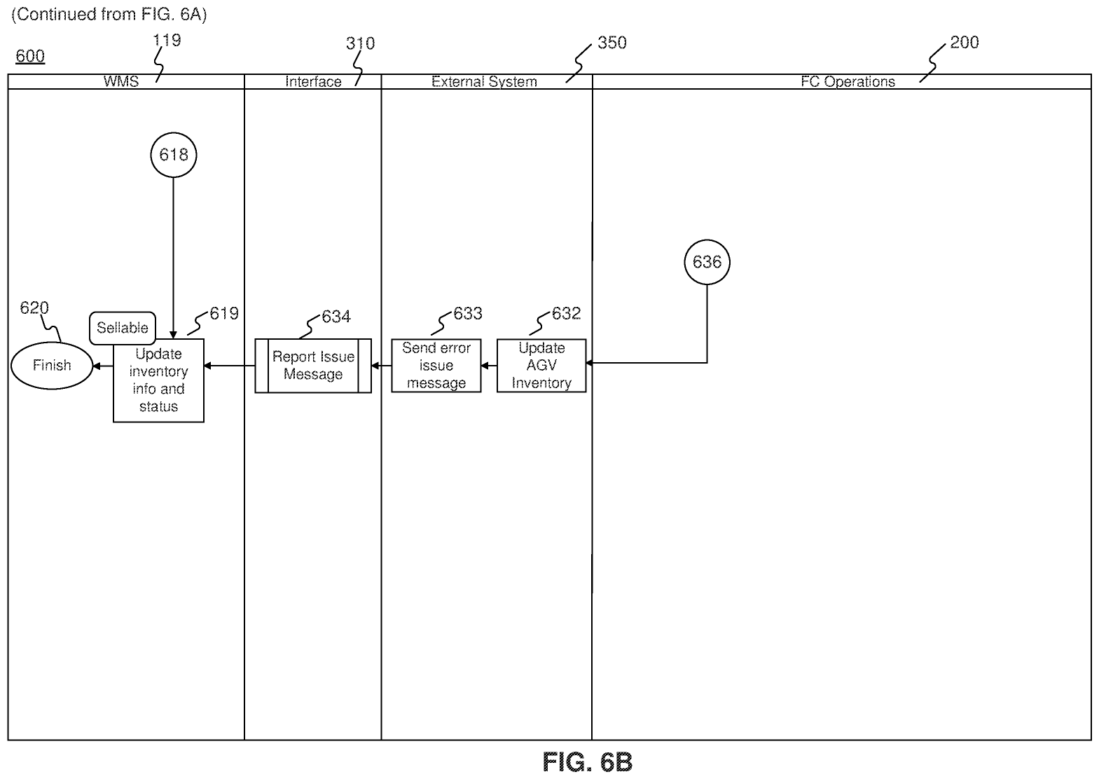

FIG. 6A is a diagram of a process 600 for product scrapping or product conversion based on manufacturing dates, consistent with the disclosed embodiments.

At step 601, WMS 119 (e.g., WMS 119 of FIG. 1A, WMS 119 of FIG. 3, etc.) may initiate a request to create a batch job for scrapping or converting SKUs of products based on their manufacturing dates. For example, WMS 119 may execute step 601 once every 24 hours, once every 12 hours, once every three calendar days, or at any other interval. WMS 119 may also execute step 601 manually (e.g., when prompted by a using a device such as mobile devices 119A-119C).

At step 602, WMS 119 may determine whether any SKUs in a FC have a pick order. In some embodiments, a pick order of a SKU is an order to retrieve (e.g., “pick”) the SKU (e.g., to evaluate the SKU or its products, to scrap the SKU or its products, to convert the SKU or its products, to sell the SKU or its products, because a customer is purchasing a product from the SKU, etc.).

At step 602a, if any SKUs in a FC have a pick order, then WMS 119 may hold off from (e.g., refrain from) creating a batch job for scrapping that SKU.

At step 602b, for the SKUs that do not have a pick order, WMS 119 may create a batch job for scrapping or converting those SKUs (e.g., scrapping or converting the “unsellable” SKUs). In some embodiments, WMS 119 may create a batch job by generating a list of SKUs, where each SKU includes at least one product (e.g., products with an expiration date, such as meat; products with a manufacturing date, such as fruit, vegetables, deli; etc.) and a registered SKU identifier. In some embodiments, the registered SKU identifier may be stored in a data structure (e.g., data structure storage 364 of FIG. 3) of WMS 119. In some embodiments, the registered SKU identifier may indicate a quantity of products in the SKU, a manufacturing date corresponding to the earliest manufacturing date of a product in the SKU, a shelf date of the SKU, a time span within which customers may safely consume a product in the SKU, etc. In some embodiments, a SKU may include a plurality of the same products, where some products may different manufacturing dates. In some embodiments, a SKU may have products that all have the same manufacturing date.

In some embodiments, generating a list of SKUs may include determining a product identifier (e.g., product name, product quantity, product manufacturing date, product shelf date, etc.) of at least one product of the SKU. In some embodiments, WMS 119 may compare each product identifier of a SKU to a threshold range and when the product identifier is within the threshold range, WMS 119 may retrieve the corresponding SKU to be included in the generated list. In some embodiments, the product identifier may be a manufacturing date of the at least one product and the threshold range may span from a current date (e.g., the date on which WMS 119 creates the corresponding batch) to the manufacturing date or earlier than the manufacturing date. That is, the threshold range may be a range of time elapsed since the manufacturing date of a product.

For example, if the threshold range is >30 days and the manufacturing date of a product in a SKU was 31 days ago, then the corresponding SKU would be included in the generated list. In this example, if the manufacturing date of a product in a SKU was 30 days ago, then the corresponding SKU would still be included in the generated list.

In some embodiments, WMS 119 may transmit the generated list of SKUs to interface 310 (e.g., interface 310 of FIG. 3).

At step 603, interface 310 may receive the generated list of SKUs from WMS 119. In response to receiving the generated list of SKUs, interface 310 may generate a manufacturing scrap picking request and a request to determine the location identifier (e.g., coordinates, location index, etc. associated with a SKU's location in a FC) associated with each SKU of the plurality of SKUs on the list.

In some embodiments, interface 310 may convert the request into a request specific to external system 350 and transmit the request to determine the location identifiers associated with the plurality of SKUs to external system 350 (e.g., external system 350 of FIG. 3). In some embodiments, external system 350 may be one of a plurality of types of external systems, and interface 310 may be configured to convert incoming requests to a format associated with any of those systems.

At step 604, external system 350 may receive the request transmitted by interface 310.

At step 605, in response to receiving the request, external system 350 may assign a task associated with the generated list of SKUs to at least one operator associated with a user device (e.g., mobile devices 119A, 119B, and 119C of FIG. 1A) and the at least one terminal of FC 200. In some embodiments, external system 350 may assign a task to at least one operator automatically based on a log of different batches generated by WMS 119. In some embodiments, at least one operator may be assigned a task based at least one of their availability, location, etc. In some embodiments, external system 350 may assign a task to a plurality of operators for a single batch. In some embodiments, external system 350 may assign a task to at least one operator by generating an interface to be displayed on a user device, where at least one operator may be assigned a task by selecting at least one SKU or batch job by interacting with the interface. In some embodiments, external system 350 may assign a task to at least one operator when an operator logs into their associated user device (see, e.g., step 606 below). In some embodiments, external system 350 may transmit an indication of the assigned task to at least one user device of FC 200.

In some embodiments, at least one operator may be associated with at least one terminal in FC 200. In some embodiments, an operator may be assigned to a terminal in FC 200 when they log into their associated user device (see, e.g., step 606 below). In some embodiments, in response to receiving the request, external system 350 may determine the location identifier associated with each SKU of the plurality of SKUs and command at least one AGV (e.g., AGVs 710 or 720 of FIG. 7) to retrieve each SKU. In some embodiments, external system 350 may command one or more AGVs to retrieve each SKU by calculating, based on the one or more AGVs, an optimal combination of AGVs and transport paths for the one or more AGVs. For example, one AGV may retrieve SKUs for different batch jobs on a single retrieving trip, thereby increasing efficiency and throughput in FC 200. In some embodiments, external system may calculate an optimal combination of AGVs and transport paths by optimizing the efficiency and throughput of FC 200 based on the size of the SKUs, density of the SKUs, location of the SKUs, etc. External system 350 may transport, by the AGV, each SKU to at least one terminal of FC 200.

At step 606, at least one operator of the assigned task may log into their associated user device.

At step 607, at least one user device of FC 200 may select and initiate the assigned task. In some embodiments, a system of FC 200 may cause a user device to display an instruction for selecting and initiating the assigned task.

At step 608, at least one user device may register a mobile receptacle (e.g., a mobile tote) with the assigned task. For example, at least one user device may associate an identifier of the mobile receptacle with the assigned task. In some embodiments, a system of FC 200 may cause a user device to display an instruction for performing this step.

At step 609, at least one operator of the assigned task may compare, by a user device associated with a terminal, the registered SKU identifier with a physical SKU identifier of a SKU at the terminal. Similar to the registered SKU identifier, the physical SKU identifier may indicate a quantity of products in the SKU, a manufacturing date corresponding to the earliest manufacturing date of a product in the SKU, a shelf date of the SKU, a time span within which customers may safely consume a product in the SKU, etc. The physical SKU identifier may be affixed to a SKU.

At step 610, an operator may determine whether the registered SKU identifier and the physical SKU identifier are consistent with each other (e.g., whether the identifiers match each other).

When the registered SKU identifier is consistent with the physical SKU identifier, then at step 611, a user device of FC 200 may perform logic steps to assess the corresponding SKU. For example, a user device may determine whether the corresponding SKU passes a quality control evaluation. In some embodiments, external system 350 may develop a user interface for the quality control evaluation, external system 350 may develop the logic for the quality control evaluation, a user device of FC 200 may initiate the quality control evaluation, and external system 350 may receive the results of the quality control evaluation from the user device.

In some embodiments, a quality control evaluation may include comparing at least one control standard to one or more of the color, size, taste, texture, firmness, or any defects (e.g., mold, deformity, bruising, ripeness, etc.) of a SKU having products. Each quality may be compared to their own standard. In some embodiments, a user device of FC 200 may perform a quality control evaluation of a SKU (e.g., by obtaining images and analyzing the images based on the control standards). In some embodiments, a user device may prompt, via a display, an operator to perform a quality control evaluation. In some embodiments, different SKUs may be evaluated for quality based on different factors depending on the type or category of SKU.

When the corresponding SKU does not pass the quality control evaluation (e.g., the SKU is not under any condition to be sold), then at step 612, a user device may enter a pick quantity of the number of products associated with the SKU under evaluation. In some embodiments, a system of FC 200 may cause a user device to display an instruction for performing this step. The pick quantity may indicate to an operator the number of products that need to be transferred from the SKU to the registered mobile receptacle to undergo a scrapping process.

At step 613, an operator may transfer the SKU to the registered mobile receptacle.

At step 614, WMS 119 may finish the scrap task by transporting, by the mobile receptacle, the corresponding SKU to an area of FC 200 to undergo a scrapping process. For example, the scrapping process may include transporting, by the mobile receptacle, the corresponding SKU to an area of FC 200 to be physically disposed of from FC 200. A user device of FC 200 may transmit an indication of the finished scrap task to external system 350.

At step 615, in response to receiving an indication of the finished scrap task from FC 200, external system 350 may modify a data structure (e.g., data structure storage 354 of FIG. 3) to deduct the corresponding SKU from the data structure. That is, external system 350 may deduct from the inventory of its data structure in communication with at least one AGV in an AGV zone of FC 200.

At step 616, external system 350 may transmit an inventory update message to interface 310 to indicate that the scrapping process and inventory update are complete.

At step 617, interface 310 may generate an inventory update message in response to receiving an inventory update message from external system 350. Interface 310 may transmit the inventory update message, or a message based on the received inventory update message, to WMS 119.

At step 618, WMS 119 may determine whether a manufacturing date of the SKU was updated.

FIG. 6B is a diagram of a continuation from FIG. 6A of process 600 for product scrapping or product conversion based on manufacturing dates, consistent with the disclosed embodiments.

If the manufacturing date of the SKU was not updated, then at step 619 of FIG. 6B, WMS 119 may update its inventory information and status. For example, WMS 119 may update its inventory information and status by modifying the registered SKU identifier of the corresponding scrapped SKU to indicate it is not sellable and modify a data structure of WMS 119 to deduct the corresponding SKU from the data structure.

At step 620, WMS 119 may finish or complete the process described above.

Turning back to step 611, when the corresponding SKU passes the quality control evaluation (e.g., the SKU is under condition to be sold), then at step 621, a user device may enter a quantity of the number of products associated with the SKU under evaluation. In some embodiments, a system of FC 200 may cause a user device to display an instruction for performing this step. The quantity may indicate to an operator the number of products that need to be transferred from the SKU to its original storage unit bin.

At step 622, a user device of FC 200 may update a manufacturing date of the corresponding SKU (e.g., automatically by one day since the SKU pass the quality control evaluation and is in condition to be sold).

At step 623, an operator may put the corresponding SKU back into its original AGV at the corresponding terminal.

At step 624, WMS 119 may finish the manufacturing date update task by transmitting, by a user device of FC 200, an indication of the finished manufacturing date update task and an indication that the SKU is to undergo conversion to external system 350.

At step 625, in response to receiving an indication of the finished manufacturing date update task from FC 200, external system 350 may command an AGV to transport the corresponding SKU to an area of FC 200 to store to be sold. In some embodiments, the AGV may transport the corresponding SKU to its original location in FC 200 (e.g., in its storage unit before process 600 commenced).

External system 350 may modify a data structure to update the manufacturing date of the corresponding SKU. That is, external system 350 may update a manufacturing date of the inventory of its data structure in communication with at least one AGV in an AGV zone of FC 200. Process 600 may proceed to step 617 and follow the steps as discussed above.

Turning back to step 610, when the registered SKU identifier is inconsistent with the physical SKU identifier, then a user device of FC 200 may perform logic steps to assess the corresponding SKU.

At step 628, a user device of FC 200 may generate a report issue menu. For example, if the manufacturing date of the registered SKU identifier does not match the manufacturing date of the physical SKU identifier, then a user device of FC 200 may generate a report issue menu for display to an operator.

At step 629, a user device may generate a select issue interface for display to an operator. In some embodiments, the generated select issue interface may be displayed on an interface of any device or system (e.g., of system 300 of FIG. 3).

At step 630, a user device (e.g., automatically) may determine the type of inconsistency between the registered SKU identifier and the physical SKU identifier. For example, the inconsistency may be a barcode scan error of the physical SKU (e.g., a user device may be unable to read a barcode of the SKU), a missing error (e.g., a user device may determine that at least one product is missing from the SKU), or a defective product error (e.g., a user device may determine that at least one product of the SKU is defective or damaged).

At step 631, WMS 119 may finish the issue reporting task by transmitting, by a user device of FC 200, an indication of the finished issue reporting task to external system 350.

At step 632 of FIG. 6B, in response to receiving an indication of the finished issue reporting task from FC 200, external system 350 may command an AGV to transport the corresponding SKU to a “problem zone” area of FC 200 to store (e.g., temporarily or permanently) without being for sale. In some embodiments, the AGV may transport the corresponding SKU to its original location in FC 200 (e.g., before process 400 commenced). In some embodiments, the AGV may transport the corresponding SKU to another location of FC 200 (e.g., based on its updated manufacturing date).

External system 350 may modify a data structure to deduct the corresponding SKU from the data structure while the SKU is in the problem zone area of FC 200. That is, external system 350 may deduct from the inventory of its data structure in communication with at least one AGV in an AGV zone of FC 200.

At step 633, external system 350 may transmit an error issue message to interface 310 to indicate that the issue reporting process is complete.

At step 634, interface 310 may generate a report issue message in response to receiving an error issue message from external system 350. Interface 310 may transmit the error issue message, or a message based on the received error issue message, to WMS 119.

At step 619, WMS 119 may update its inventory information and status in response to receiving an error issue message from interface 310. For example, WMS 119 may update its inventory information and status by modifying the registered SKU identifier of the corresponding SKU to indicate it is not sellable and modify a data structure of WMS 119 to deduct the corresponding SKU from the data structure.

At step 620, WMS 119 may finish or complete the process described above.

Turning back to step 618, if the manufacturing date of the SKU was updated, then at step 640, WMS 119 may determine whether the SKU is a converted SKU (e.g., the SKU has a price that is discounted from its original price).

If the corresponding SKU is not a converted SKU, then at step 641, WMS 119 may convert the corresponding SKU into a SKU with a discounted price. The conversion process may include calculating a discount value of the corresponding SKU based on the registered SKU identifier, modifying the registered SKU identifier of the corresponding SKU to apply the calculated discount value, and modifying the registered SKU identifier of the corresponding SKU to indicate it is sellable. In some embodiments, WMS 119 may calculate a discount value of the corresponding SKU based on the time span between a current date and a manufacturing date of the corresponding SKU (e.g., the discount value may be higher if the time span between the current date and the manufacturing date is lower; the discount value may be lower if the time span between the current date and the manufacturing date is higher; etc.).

In some embodiments, WMS 119 may calculate a discount value of the corresponding SKU based on the type of products in the SKU (e.g., products that have a shorter time period to safely consume may have a higher discount than products that have a longer time period to safely consume). In some embodiments, WMS 119 may calculate a discount value using different standards for different SKU categories (e.g., the discount for a first category of SKUs may be calculated using a first standard while the discount for a second category of SKUs may be calculated using a second standard). In some embodiments, a minimum discount may be applied to a SKU based on the category of SKU. In some embodiments, WMS 119 may calculate a discount for a SKU that already has a discounted price according to a standard that is different from calculating a discount for a SKU that does not have a discounted price (e.g., it has its original price). In some embodiments, WMS 119 may calculate a discount value based on the shelf life of a SKU. In some embodiments, WMS 119 may apply more discounts to a SKU as more time passes without the SKU being sold.

At step 642, WMS 119 may transmit a send manufacture date update message to interface 310.

At step 643, interface 310 may generate an inventory update message in response to receiving the send manufacture date update message from WMS 119.

At step 644, in response to receiving an inventory update message from interface 310, external system 350 may modify its data structure to indicate that the corresponding SKU has been converted into a SKU with a discounted price. External system 350 may update the inventory of its data structure in communication with at least one AGV in an AGV zone of FC 200. For example, external system 350 may modify its data structure to update the registered SKU identifier of the corresponding SKU to indicate it has undergone a conversion process and to modify its price to the converted price.

Turning back to step 640, if the corresponding SKU is a converted SKU, then process 600 may proceed to step 642 and the steps described above.

Turning to step 636, after any one of steps 614, 624, or 631, a user device of FC 200 may proceed to step 637 to determine whether another SKU needs to be evaluated.

If another SKU needs to be evaluated, then at step 638 a user device may check the next SKU that needs to be evaluated and proceed to step 611, repeating the process steps described above.

If another SKU does not need to be evaluated, then at step 639 a user device in FC 200 may complete the process described above.

It should be understood that a plurality of SKUs may undergo any one of processes 400, 500, or 600 substantially simultaneously. For example, a SKU may undergo one or more steps of processes 400, 500, or 600 while another SKU of another batch undergoes one or more steps of 400, 500, or 600.

FIG. 7 is a schematic diagram illustrating an AGV 710 and an AGV 720, consistent with the disclosed embodiments.

In some embodiments, each AGV may include one or more bins or shelves 730, where each bin or shelf may carry one or more products 732. In some embodiments, AGVs 710 and 720 may each include one or more motors, wheels, sensors, etc. (e.g., at 740 of the AGV) to enable AGVs 710 or 720 to be mobile.

In some embodiments, AGVs 710 and 720 may be managed by an external system (e.g., external system 350 of FIGS. 3-6B). In some embodiments, AGVs 710 or 720 may carry and transport one or more SKUs of products. AGVs 710 or 720 may traverse a certain area or zone of FC 200 that is separate from the areas or zones occupied by operators or mobile devices 119A, 119B, and 119C. Advantageously, AGVs 710 or 720 may transport various SKUs of products from storage in FC 200 to one or more terminals of FC 200, where operators or mobile devices may access the SKUs at these one or more terminals. That is, operators or mobile devices may remain stationary at one or more terminals while AGVs 710 or 720 transport SKUs in FC 200 between storage units and terminals.

It should be understood that while only two AGVs are depicted in FIG. 7, any number of AGVs may be used in a FC.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented system for product scrapping and processing, the system comprising:
a memory storing instructions; and
at least one processor configured to execute the instructions to:
generate a list of stock keeping units (SKUs), wherein each SKU comprises at least one product and a registered SKU identifier;
transmit the list of SKUs to an interface,
in response to receiving the list of SKUs, the interface:
generates a request to determine a location identifier associated with each SKU of the plurality of SKUs, and
transmits the request to an external system to cause the external system to:
determine the location identifier associated with each SKU,
command at least one automated guided vehicle (AGV) to retrieve each SKU, and
transport each SKU to at least one terminal;
compare, by a user device associated with the at least one terminal, the registered SKU identifier with a physical SKU identifier;
when the registered SKU identifier is consistent with the physical SKU identifier:
transport the corresponding SKU to undergo a scrapping process or a conversion process;
when the registered SKU identifier is inconsistent with the physical SKU identifier:
perform logic steps to assess the corresponding SKU, and
modify the registered SKU identifier according to results of the performed logic steps.

2. The computer-implemented system of claim 1, wherein generating the list of SKUs comprises:
determining a product identifier of the at least one product of each SKU;
comparing the product identifier to a threshold range; and
when the product identifier is within the threshold range, retrieving the SKU comprising the corresponding at least one product.

3. The computer-implemented system of claim 2, wherein the product identifier is an expiration date of the at least one product and the threshold range spans from a current date or earlier.

4. The computer-implemented system of claim 2, wherein the product identifier is a manufacturing date of the at least one product and the threshold range is a range of time elapsed since the manufacturing date.

5. The computer-implemented system of claim 1, wherein in response to receiving the request, the interface is configured to cause the external system to assign a task associated with the generated list of SKUs to at least one operator associated with the user device and the at least one terminal.

6. The computer-implemented system of claim 1, wherein when the registered SKU identifier is consistent with the physical SKU identifier, the at least one processor is configured to execute the instructions to:
transport, by the mobile receptacle, the corresponding SKU to undergo the scrapping process; and
modify the registered SKU identifier of the corresponding SKU to indicate it is not sellable.

7. The computer-implemented system of claim 1, wherein when the registered SKU identifier is consistent with the physical SKU identifier, the at least one processor is configured to execute the instructions to:
transport, by the AGV, the corresponding SKU to undergo the conversion process, wherein the conversion process comprises:
calculating a discount value of the corresponding SKU based on the registered SKU identifier; and
modifying the registered SKU identifier of the corresponding SKU to apply the calculated discount value.

8. The computer-implemented system of claim 1, wherein when the registered SKU identifier is consistent with the physical SKU identifier, the at least one processor is configured to execute the instructions to:
perform a quality control evaluation on the corresponding SKU;
when the corresponding SKU fails the quality control evaluation:
transport, by the mobile receptacle, the corresponding SKU to undergo the scrapping process;
when the corresponding SKU passes the quality control evaluation:
modify the SKU identifier to increase an associated manufacturing date by one day, and
transport, by the AGV, the corresponding SKU to undergo the conversion process.

9. The computer-implemented system of claim 1, wherein the registered SKU identifier and the physical SKU identifier each comprise an expiration date of the at least one product and when the registered SKU identifier is inconsistent with the physical SKU identifier, the at least one processor is configured to execute the instructions to:
determine that the expiration date of the registered SKU identifier is inconsistent with the expiration date of the physical SKU identifier; and
modify the expiration date of the registered SKU identifier to be the expiration date of the physical SKU identifier.

10. The computer-implemented system of claim 1, wherein when the registered SKU identifier is inconsistent with the physical SKU identifier, the results of the performed logic steps comprise an indication of at least one of a barcode scan error, a shortage error, or a defective product error.

11. The computer-implemented system of claim 1, wherein the computer-implemented system and the user device are unable to determine the location identifier associated with each SKU.

12. The computer-implemented system of claim 1, wherein the scrapping process comprises:
transporting, by the mobile receptacle, the corresponding SKU to be physically disposed of from a warehouse;
modifying the registered SKU identifier of the corresponding SKU to indicate it is not sellable;
modifying a data structure of the computer-implemented system to deduct the corresponding SKU from the data structure of the computer-implemented system; and
transmitting a message to the external system to cause the external system to modify a data structure of the external system to deduct the corresponding SKU from the data structure of the external system.

13. The computer-implemented system of claim 1, wherein the conversion process comprises:
transporting, by the AGV, the corresponding SKU to its designated location in a warehouse;
calculating a discount value of the corresponding SKU based on the registered SKU identifier;
modifying the registered SKU identifier of the corresponding SKU to apply the calculated discount value;
modifying the registered SKU identifier of the corresponding SKU to indicate it is sellable;
modifying a data structure of the computer-implemented system to update the registered SKU identifier of the corresponding SKU; and
transmitting a message to the external system to cause the external system to modify a data structure of the external system to update the registered SKU identifier of the corresponding SKU.

14. A computer-implemented method for product scrapping and processing, the system comprising:
generating a list of stock keeping units (SKUs), wherein each SKU comprises at least one product and a registered SKU identifier;
transmitting the list of SKUs to an interface,
in response to receiving the list of SKUs, the interface:
generating a request to determine a location identifier associated with each SKU of the plurality of SKUs, and
transmitting the request to an external system to cause the external system to:
determine the location identifier associated with each SKU,
command at least one automated guided vehicle (AGV) to retrieve each SKU, and
transport each SKU to at least one terminal;
comparing, by a user device associated with the at least one terminal, the registered SKU identifier with a physical SKU identifier;
when the registered SKU identifier is consistent with the physical SKU identifier:
transporting the corresponding SKU to undergo a scrapping process or a conversion process;
when the registered SKU identifier is inconsistent with the physical SKU identifier:
performing logic steps to assess the corresponding SKU, and
modifying the registered SKU identifier according to results of the performed logic steps.

15. The computer-implemented method of claim 11, wherein generating the list of SKUs comprises:
determining a product identifier of the at least one product of each SKU;
comparing the product identifier to a threshold range; and
when the product identifier is within the threshold range, retrieving the SKU comprising the corresponding at least one product.

16. The computer-implemented method of claim 15, wherein the product identifier is an expiration date of the at least one product and the threshold range spans from a current date or earlier.

17. The computer-implemented method of claim 15, wherein the product identifier is a manufacturing date of the at least one product and the threshold range is a range of time elapsed since the manufacturing date.

18. The computer-implemented method of claim 11, wherein when the registered SKU identifier is consistent with the physical SKU identifier, further comprising:
performing a quality control evaluation on the corresponding SKU;
when the corresponding SKU fails the quality control evaluation:
transporting, by the mobile receptacle, the corresponding SKU to undergo the scrapping process;
when the corresponding SKU passes the quality control evaluation:
modifying the SKU identifier to increase an associated manufacturing date by one day, and
transporting, by the AGV, the corresponding SKU to undergo the conversion process.

19. A computer-implemented system for product scrapping and processing, the system comprising:
a memory storing instructions; and
at least one processor configured to execute the instructions to:
generate a list of stock keeping units (SKUs), wherein each SKU comprises at least one product and a registered SKU identifier;
transmit the list of SKUs to an interface,
in response to receiving the list of SKUs, the interface:
generates a request to determine a location identifier associated with each SKU of the plurality of SKUs, and
transmits the request to an external system to cause the external system to:
determine the location identifier associated with each SKU, command at least one automated guided vehicle (AGV) to retrieve each SKU, and transport each SKU to at least one terminal;
compare, by a user device associated with the at least one terminal, the registered SKU identifier with a physical SKU identifier;
when the registered SKU identifier is consistent with the physical SKU identifier:
transport the corresponding SKU to undergo a scrapping process or a conversion process;
when the registered SKU identifier is inconsistent with the physical SKU identifier:
perform logic steps to assess the corresponding SKU, and
modify the registered SKU identifier according to results of the performed logic steps;
modify a data structure of the computer-implemented system and send a message to the external system to cause a data structure of the external system to be modified according to any one of the scrapping process, the conversion process, or the results of the performed logic steps of the corresponding SKU; and
modify the registered SKU identifier of the corresponding SKU to indicate whether it is sellable.

20. The computer-implemented system of claim 19, wherein transmitting the request to the external system further causes the external system to assign a task associated with the data structure of the computer-implemented system and the data structure of the external system are independent of each other.
